(19) United States
(12) Patent Application Publication
(10) Pub. No.: US 2024/0348049 A1
(43) Pub. Date: Oct. 17, 2024

(54) BIDIRECTIONAL WAVEFORM SHAPING FOR GRID-TIED APPLICATIONS

(71) Applicant: Apparent Labs, LLC, Novato, CA (US)

(72) Inventors: Fred C. HORTON, Santa Rosa, CA (US); Frank P. MARRONE, Cloverdale, CA (US); Stefan MATAN, Novato, CA (US)

(21) Appl. No.: 18/291,549

(22) PCT Filed: Jul. 25, 2022
(86) PCT No.: PCT/US22/38222

§ 371 Date: Jan. 23, 2024

Related U.S. Application Data
(60) Provisional application No. 63/225,275, filed on Jul. 23, 2021.

(51) Int. Cl. H02J 3/06; H02J 3/36; H02M 7/797

(52) U.S. Cl. CPC H02J 3/06; H02J 3/36; H02M 7/797

(57) ABSTRACT

A system interconnects a power grid to a local interconnection to a local application. The system interconnection can provide bidirectional power control between the local interconnection and the power grid. The system includes a bridge circuit having cross-connected switches inline with a high voltage path of the power grid. The system includes a direct current (DC) link to transfer energy between the local interconnection and the bridge circuit. The system has a controller to control the bridge circuit and the DC link to provide bidirectional waveform shaping of an alternating current (AC) current waveform to interconnect with the power grid.

### PRIORITY

This application is based on, and claims the benefit of priority to, U.S. Provisional Application No. 63/225,275, filed Jul. 23, 2021, and to PCT Application PCT/US22/38222, filed Jul. 25, 2022.

### FIELD

Descriptions are generally related to an electrical power grid, and more particular descriptions are related to the flow of power between the power grid and grid-tied applications.

### BACKGROUND

There are many systems that connect to the grid, which can be referred to as grid-tied systems. A grid-tied system has an electrical connection to a power grid controlled by a utility. The utility controls the power grid with dispatch control signals to power providers and service operators.

A traditional power grid is built to provide power from a central power plant to multiple consumers. With the increase of distributed energy resources (DERs), there are many energy generation resources that provide power back into the grid, which can be disruptive to the power flow management by the grid. There are also applications where a consumer would like to disconnect from the grid and provide a microgrid, which is a power grid that operates outside the control of the utility. Building a microgrid that is self-contained makes a power network that cannot benefit from the grid resources when needed or convenient. However, connecting a microgrid to the utility grid can be complicated and expensive.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 illustrates an example of a bidirectional grid connection system.

FIG. 2 illustrates an example of a bidirectional interconnection system with a consumer application.

FIG. 3 illustrates an example of a bidirectional interconnection system with a battery consumer application.

FIG. 4 illustrates an example of a bidirectional interconnection system with a load consumer application.

FIG. 5 illustrates an example of a bidirectional interconnection system with a microgrid.

FIG. 6 illustrates an example of a bidirectional interconnection system with microgrid and a consumer application in parallel with the microgrid.

FIG. 7 illustrates an example of a system for bidirectional power transfer.

FIG. 8 is a block diagram of an example of a system with bidirectional power transfer based on measuring by internal current sensors.

FIG. 9 is a block diagram of an example of a consumer node with bidirectional power transfer.

FIG. 10 is a block diagram of an example of a DER node for a bidirectional distributed power.

FIG. 11A is a block diagram of an example of an enclosure with multiple meters.

FIG. 11B represents an example of a 4-quadrant meter.

FIG. 12 is a graphical representation of an example of components of a current in a system in which harmonic components of current have angular offsets with respect to a primary current component.

FIG. 13 is a graphical representation of an example of a grid current vector mapped against a local system current vector.

FIG. 14 is a block diagram of an example of a metering device that monitors power at a PCC with direction control.

FIG. 15 is a flow diagram of an example of a process for providing bidirectional energy transfer.

Descriptions of certain details and implementations follow, including non-limiting descriptions of the figures, which may depict some or all examples, and well as other potential implementations.

### DETAILED DESCRIPTION

As described herein, a system interconnects a power grid to a local interconnection to a local application. The system interconnection can provide bidirectional power control between the local interconnection and the power grid. The system includes a bridge circuit having cross-connected switches inline with a high voltage path of the power grid. The system includes a direct current (DC) link to transfer energy between the local interconnection and the bridge circuit. The system has a controller to control the bridge circuit and the DC link to provide bidirectional waveform shaping of an alternating current (AC) current waveform to interconnect with the power grid.

The bidirectional grid connection system allows a consumer to connect different types of applications to a grid interconnection, and selectively decouple from the power grid. The bidirectional grid connection system can provide waveform shaping both in the interconnection to the grid, to provide grid compliance of power output to the grid, and waveform shaping within the local system to provide features for local power consumption and storage as those provided to the grid. Thus, the grid connection system can allow power factor correction, reactive power management, frequency support, phase control, and other features facing downstream from the point of common contact (PCC) to the utility power grid.

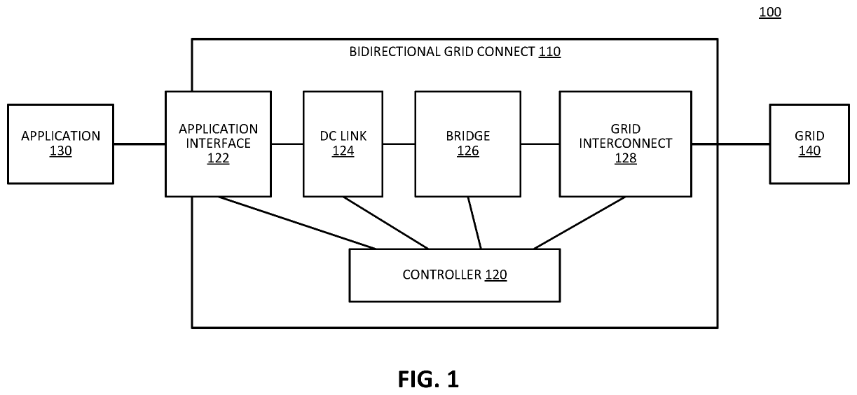

FIG. 1 illustrates an example of a bidirectional grid connection system. Bidirectional grid connect 110 or bidirectional grid interconnect represents a component or device that provides grid interconnection of application 130 to grid 140. Grid 140 represents a utility grid or grid network that provides electrical power to consumers.

In system 100, bidirectional grid connect 110 can include application interface 122, DC (direct current) link 124, bridge circuit 126, grid interconnect circuitry 128, and control circuitry and software, represented by controller 120. On the grid-facing side, grid interconnect 128 represents hardware that connects bidirectional grid connect 110 to grid 140. On the consumer side, application interface 122 represents hardware that connects to an application. Application 130 represents a power consuming application, a power generating application, or an application that consumes power and generates power.

Application 130 can represent any type of electrical power system that can be connected directly or indirectly with a power grid. In one example, application 130 is a battery or other energy storage system. In one example, application 130 is a power source, such as a renewable energy generator, such as solar, wind, or geothermal generator. In one example, application 130 is an AC (alternating current) circuit that provides a microgrid that can be selectively decoupled from the utility grid represented by grid 140. Examples of applications can include combinations of any of the applications referred to above. The combinations can include one or more of any of the applications with one or more of any of the other applications.

Application interface 122 may not be necessary in all cases, and in some cases can be considered part of application 130 itself. In system 100, application interface 122 is illustrated as partly within and partly outside bidirectional grid connect 110 to represent that it can be part of the interconnect device that couples to grid 140, or can be part of the application itself. Some applications, such as a microgrid AC interface, can be the interface itself, allowing other applications to be connected to the microgrid application. Some DC applications can include a managed DC interface as application 130, allowing the interconnection of other DC applications on the consumer side of the DC interface.

Application interface 122 can include any hardware or circuitry to connect application 130 to bidirectional grid connect 110. Application interface 122 enables bidirectional grid connect 110 to shape the waveform provided to application 130, enabling bidirectional grid connect 110 to provide waveform control for the power provided to application 130.

DC link 124 represents a DC circuit that can provide a high voltage interconnection between DC sources and loads with the AC power of grid 140. Bridge 126 represents circuitry to convert between DC energy and AC power. Bridge 126 can convert DC energy into AC power and shape the waveform to a desired current waveform to interconnect with grid 140 for transfer of power from application 130 through bidirectional grid connect 110 to grid 140. Bridge 126 can shape the waveform of AC power to a desired current waveform and convert the shaped AC power into DC power to deliver from grid 140 through bidirectional grid connect 110 to application 130. The shaping of the current waveform enables bidirectional grid connect 110 to connect to grid 140 at any target phase angle while reducing or eliminating waveform distortion.

The waveform shaping can include total harmonic distortion (THD) control, enabling system 100 to provide a clean current waveform that is free of energy in harmonics. System 100 having bidirectional grid connect 110 with waveform shaping can provide the clean current waveform from application 130 to grid 140 or from grid 140 to application 130. In one example, system 100 provides total harmonic distortion through waveform shaping with setpoint control of a generated current waveform, generating an idealized form of the target output current waveform, and at any desired phase offset or in-phase with the grid voltage of grid 140.

Bridge 126 can be referred to as an “H-bridge” that selectively switches the power lines interconnecting to grid 140 to convert the AC signal into a virtual DC signal. When drawing power, the switching can charge a high voltage DC link (e.g., DC link 124) as an energy source or energy store to provide energy to the consumer system. When providing power from consumer generation to grid 140, the DC energy can charge DC link 124, where the switching allows the power to be converted to an AC signal to provide onto grid 140.

Grid interconnect 128 can provide isolation circuitry, such as transformers, to indirectly drive the power signals between the consumer side and the grid side. Grid interconnect 128 represents circuitry that provides another layer of indirection on the power connection for system 100, providing the AC power indirectly between grid 140 and bridge 126 to enable bridge 126 to perform the high speed switching of the power signal to interconnect in both directions. The isolation can enable the waveform shaping to selectively provide any phase angle and current waveform shape with respect to the current and voltage waveforms of grid 140. With isolation, bidirectional grid connect 110 passes energy between application 130 and grid 140 without being directly tied to a phase or waveform shape of the grid. Such isolation and waveform shaping is in contrast to other grid interconnections that are electrically tied to the power waveforms of the grid, as opposed to simply tying the energy to the grid while being able to change the waveform.

In contrast to traditional grid interconnect devices or grid interconnect systems, bidirectional grid connect 110 does not need a hardware switch, because the power connection to the grid is controlled in DC link 124 and bridge 126 with high-speed switching. The switching can be controlled in accordance with the setpoints and a waveform generator (e.g., a pulse width modulator (PWM)) to generate the target interconnection waveform. Bidirectional grid connect 110 does not need a traditional hardware relay, as the system can self-isolate by turning off its interconnection waveform internally within DC link 124 and bridge 126, enabling non-export control. Controller 120 controls the interconnection waveform, to determine whether the energy will transfer through bidirectional grid connect 110. Thus, by stopping the generation of a current waveform within bidirectional grid connect 110, system 100 disconnects application 130 from grid 140.

Additionally, the control of the interconnection waveform allows system 100 to continue to operate internally, whether or not there is power on grid 140. Thus, if application 130 includes power generation and power consumption, bidirectional grid connect 110 can continue to transfer power internally from the power generation source to the power consumption device, even if disconnected from grid 140.

Controller 120 represents control hardware and software to provide control signals to application interface 122 or the application itself, depending on the application type, to enable application 130 to connect with bidirectional grid connect 110. The control can include, for example, switching control and energy flow control. Controller 120 represents control hardware and software to provide control signals to manage the operation of the DC circuitry of DC link 124, such as switching control and energy flow control.

Controller 120 represents control hardware and software to provide control signals for switching to provide waveform shaping for the bridge circuitry of bridge 126. Controller 120 represents control hardware and software to provide control signals for switching control and interconnection control for the grid interconnect hardware of grid interconnect 128. The interconnection control can enable selective disconnection from grid 140.

It will be understood that reference above to software can also refer to embedded code (such as firmware) loaded on control components. Thus, controller 120 represents at least control hardware. Through software or firmware or a combination of software and firmware, the control hardware can be configured or enabled to be capable of control operations to manage or control the components of bidirectional grid connect 110.

In one example, bidirectional grid connect 110 represents a power converter device. In one example, bidirectional grid connect 110 represents a microinverter device. In one example, bidirectional grid connect 110 has a one-to-one relationship with application 130. In a one-to-one relationship, there is one hardware device for bidirectional grid connect 110 for a single application 130. In one example, there is one hardware device for a single power source or a single battery. In one example, there is one hardware device for a single load, such as an air conditioning unit. In one example, there is one hardware device for multiple loads. In one example, there is one hardware device for multiple power sources.

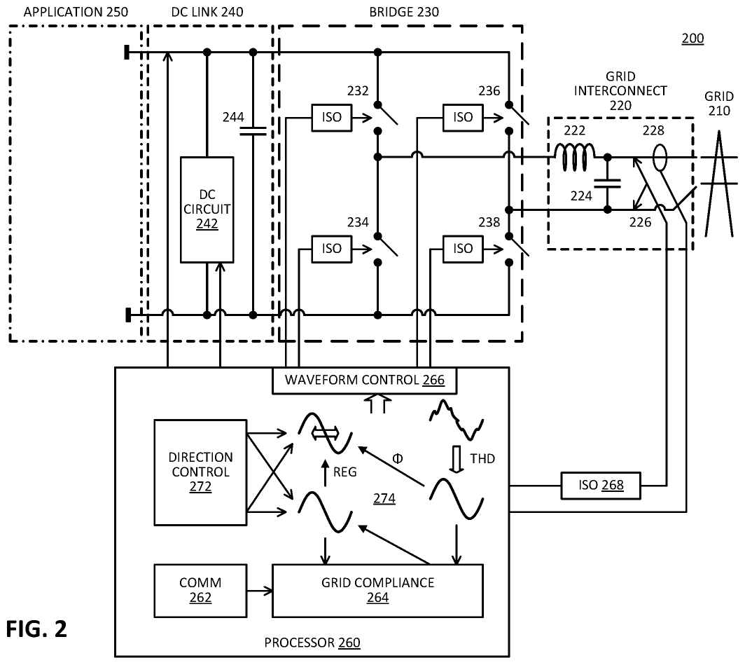

FIG. 2 illustrates an example of a bidirectional interconnection system with a consumer application. System 200 represents a system or a power transfer device or a power transfer system in accordance with an example of system 100. System 200 represents a connection point for an application to the DC link. Application 250 represents a grid-connectable application to couple to DC link 240, which connects with bridge 230. Bridge 230 represents a bridge circuit that selectively connects to grid 210 through grid interconnect hardware, represented by grid interconnect 220.

DC link 240 can include a capacitor, capacitor bank, battery, battery bank, or other energy storage resource. Capacitor 244 represents the energy storage resource of DC link 240. Capacitor 244 or the energy storage resource provides an internal node that can be charged with energy. The internal node provides an energy reservoir to allow switching between DC and AC power signals with switching circuitry. DC link 240 includes DC circuit 242, which can include one or more magnetic energy devices, such as inductors or transformers, to allow conversion of energy from a source into an energy output. The source can be grid 210 for loading conditions and can be an internal power source as an application for conditions where power is provided from application 250 to grid 210. DC link 240 can transfer energy as a DC current between a local interconnection for application 250 and bridge 230.

Bridge 230 is represented as a simplified bridge circuit having cross-connected switching circuits or switching components. The control of the switches can be isolated, as represented by the “ISO” components. The isolation enables control of the switching of the AC power outside the AC power domain. Thus, the switches can be in the high-power or high-voltage domain or inline with the high-voltage path, and the switch control can be a low-voltage or low-power domain separate from the power path.

Grid interconnect 220 is represented with inductor 222 inline in the high-voltage path, and capacitor 224 coupled between the high-voltage and low-voltage paths. The combination of a series inductor and a capacitor between the paths (a parallel capacitor) is generally understood as a signal filtering circuit. The filter circuit represents signal waveform shaping of grid interconnect 220 to interface with the grid. System 200 represents the filter circuit but does not explicitly the circuit elements that provide interconnection to grid 210. Rather than explicitly including inductor 222 and capacitor 224 as a filter circuit, the filter circuit can be part of interconnection hardware components.

The arrows represent voltage measurement 226, and the circle around the power line represents current measurement 228. Current measurement 228 is isolated when performed with Hall effect sensors or inductive measurement. In one example, voltage measurement 226 includes isolation block, represented by ISO 268, to explicitly show the isolation of the voltage measurement. The isolation can include, for example, optical measurement components. With ISO 268, processor 260 can monitor the grid current and the grid voltage without being directly inline with the high-power signal line.

Voltage measurement 226 represents a sensor device to monitor AC voltage of the power grid. Current measurement 228 represents a sensor device to monitor AC current of the power grid. The current measurement and the voltage measurement can be considered to be on the grid side of grid interconnect 220, seeing that the measurements are illustrated between the interconnect hardware and grid 210. The consumer side of grid interconnect 220 can be considered to be between the interconnect hardware and bridge 230. The measurement can be made with one or more sensor components that sense grid conditions.

In bridge 230, the cross-connected switches are represented as control-signal isolated switches, with the switch and the ISO block. The ISO block represents switching control that is electrically isolated from the high voltage or high power path of the grid. Switch 232 and switch 234 are connected in series between the high voltage signal and low voltage signal of bridge 230, with the node between switch 232 and switch 234 connected to the high voltage grid line through inductor 222. Switch 236 and switch 238 are connected in series between the high voltage signal and the low voltage signal of bridge 230, with the node between switch 236 and switch 238 connected to the low voltage grid line.

Bridge 230 is illustrated as having switching control managed by waveform control 266 of processor 260, which represents the processing circuitry or controller of system 200. Waveform control 266 is represented by diagram 274 within processor 260. The waveform with the angles and distorted line represents a waveform measured off the grid, with the measurement components. The THD represents total harmonic distortion control through the use of table-based or setpoint based idealized waveform generation. The idealized waveform is represented below the distorted waveform, and has no distortion.

The generated waveform can be an input to grid compliance components, represented by grid compliance 264. Grid compliance 264 produces a desired waveform, which can be managed or regulated for phase (REG). The left and right arrow with the top left waveform represents the ability to set the phase angle (@) to any desired phase angle. Direction control 272 represents components that can perform computations and provide input to manage the angle of the generated waveform and the shape, amplitude, and frequency of the waveform based on whether power is drawn from grid 210 or supplied to grid 210.

Grid compliance 264 can include settings that manage the switching of the AC interconnection bridge of bridge 230. The settings can be applied by the waveform generation hardware to generate the target waveform at the target phase. The target phase can be a phase that will put the generated current waveform in phase with the grid voltage for unity power factor, or at a desired offset with respect to the grid voltage to generate reactive power. By generating the waveform out of phase with respect to the grid voltage, system 200 can generate reactive power for reactive power injection into the system, rather than simply providing reactive power loading with inductors and/or capacitors that consume energy to adjust the phase offset.

The settings can be preconfigured settings stored in processor 260 or in a memory device (not explicitly shown) accessible to processor 260. Preconfigured settings can include, for example, setpoints or table information with data for generating an output waveform. The settings can include settings computed in realtime by processor 260. The settings can include settings based on information provided by local sensors within system 200 (such as sensors that gather information monitored by a grid meter), by information provided by a gateway device, by information provided by grid management or dispatch information, or other information used to operate the hardware to shape the waveforms.

Communication (COMM) 262 represents one or more components for providing communication to processor 260. The communication can include grid dispatch information. Thus, system 200 can be fully dispatchable by the utility. With the switching control in response to the utility communication, system 200 can be a virtual spinning generator, having realtime phase and reactive power control as with a spinning generator, although system 200 does not need a spinning component to generate the AC signal. Rather, the processor generates the target AC signal waveform and controls the AC bridge and DC link to transition energy between DC and AC.

In one example, the communication can include communication from local measurement or sensor components. In one example, system 200 is part of a consumer system having a gateway device that measures operation within a consumer premises and provides feedback or provides measurements based on the operation of the grid interconnection for the consumer premises, or different components that source or load power within the consumer premises, or grid conditions, or any combination of any one or more of these. In one example, system 200 is implemented in an enclosure or system that includes sensors that provide internal 4-quadrant meter measurements, and processor 260 provides control signals to DC link 240 and bridge 230 based on the sensor measurements. System 200 can also measure the high voltage DC line of DC link 240, as illustrated by the arrow from processor 260 to the high voltage line. The arrow to DC circuit 242 represents the control by processor 260 of the DC circuitry.

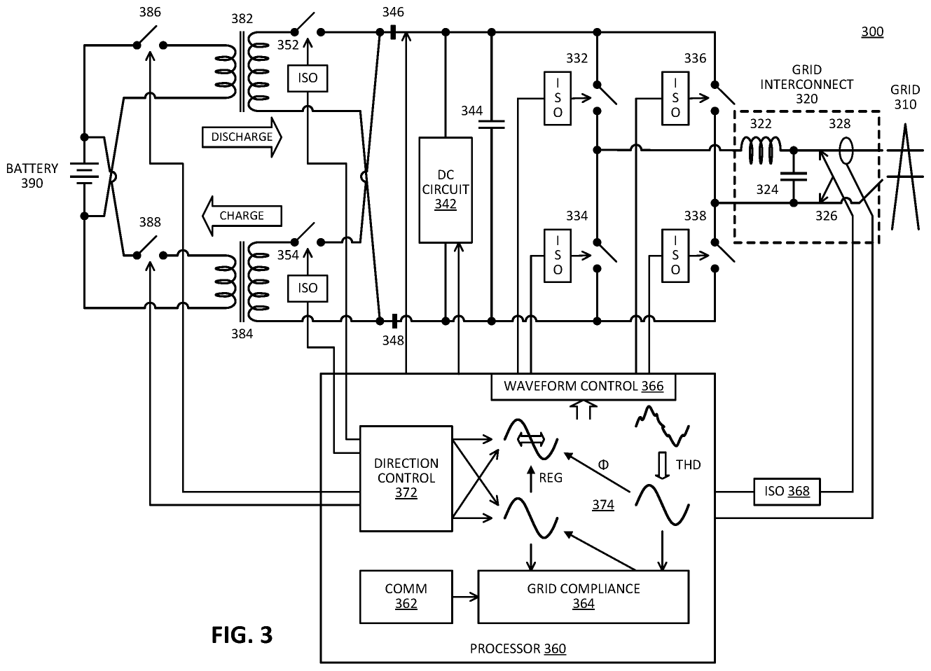

FIG. 3 illustrates an example of a bidirectional interconnection system with a battery consumer application. System 300 represents a system or a power transfer device or a power transfer system in accordance with an example of system 100 or an example of system 200. System 300 illustrates an application that enables charging and discharging a battery on the consumer premises.

The descriptions of system 200 apply to similar components of system 300. More specifically, the descriptions of system 200 can apply to similarly numbered components as grid 310, grid interconnect 320, inductor 322, capacitor 324, voltage measurement 326, current measurement 328, ISO 368, processor 360, communication (COMM) 362, grid compliance 364, waveform control 366, direction control 372, and waveform diagram 374.

System 300 includes a bridge circuit represented by switches with high voltage isolation (ISO) that are cross connected and coupled to the grid voltage and neutral. More specifically, the bridge circuit includes switch 332 coupled in series with switch 334 between the bridge high voltage and low voltage, where the high voltage signal is received in the node between the switches. The bridge circuit also includes switch 336 coupled in series with switch 338 between the bridge high voltage and low voltage, where the grid neutral signal is received in the node between the switches. System 300 includes a DC link represented by DC circuit 342 and capacitor 344. Processor 360 can measure the DC link high voltage signal and provide control signals to DC circuit 342. The descriptions of system 200 apply to similarly numbered components of system 300.

System 300 illustrates node 346 and node 348, which represent local interconnection points of the bidirectional energy transfer system. The components to the left of node 346 and node 348 can be considered the local application connected to the DC link. Node 346 can represent a connection point to a high voltage signal. Node 348 can represent a connection point to a low voltage signal.

The application includes battery 390 that can be charged or discharged. Battery 390 represents an energy storage component, such as a traditional battery, a potential energy system, or other storage. In the example of system 300, battery 390 can be charged with power from grid 310, and can provide power to the consumer premises or can provide power to grid 310. At the connection points of node 346 and node 348, other components (such as loads or power sources) can also be connected. Power sources connected to the DC link can be used to charge battery 390 (charge). Loads connected to the DC link can be powered with power from battery 390 (discharge).

In one example, the battery application includes transformer 382 controlled by isolated switch 352 and transformer 384 controlled by isolated switch 354. Transformer 382 has the larger number of windings coupled between node 346 and node 348 and the lower number of windings coupled between the top and bottom of battery 390. Switch 352 selectively switches the connection of node 346 to the windings. In one example, the connection to the top of battery 390 is controlled by switch 386. Transformer 384 has the larger number of windings coupled between node 346 and node 348 and the lower number of windings coupled between the top and bottom of battery 390. Switch 354 selectively switches the connection of node 348 to the windings. In one example, the connection to the top of battery 390 is controlled by switch 388.

System 300 represents isolated control to control switching of transformer 382 and transformer 384, which allows switching of high-voltage DC power from processor 360. In one example, system 300 can include switching control on the battery side of the transformers, represented by switch 386 to transformer 382 and switch 388 to transformer 384, to allow step-up operation for discharge and step-down operation for charge. As illustrated, direction control 372 within processor 360 can control the switching on both sides of the transformers to control the flow of energy into or out of battery 390.

When there is a power source or a load coupled to node 346 and node 348 in addition to battery 390, processor 360 can control the switching of transformer 382 and transformer 384 in accordance with a desired flow of energy to/from the other component and battery 390. Controlling the switching with direction control 372 enables system 300 to bidirectionally control the flow of energy, and the bridge circuit or the bridge circuit and the DC link can perform bidirectional waveform shaping of the energy flow between grid 310 and the application.

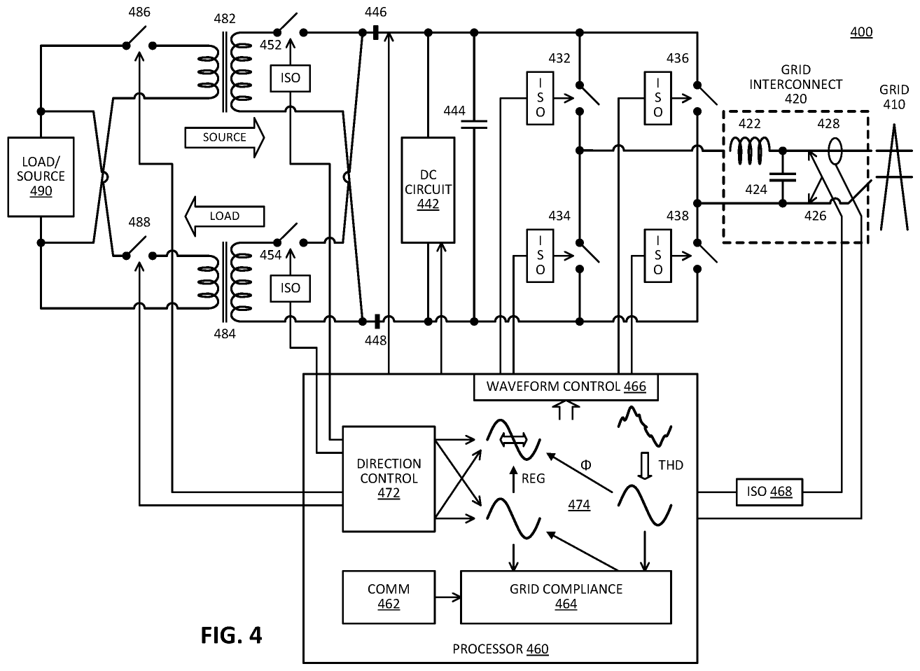

FIG. 4 illustrates an example of a bidirectional interconnection system with a load consumer application. System 400 represents a system or a power transfer device or a power transfer system in accordance with an example of system 100 or an example of system 200. System 400 illustrates an application that enables sourcing and loading power to one or more source or load components within a consumer premises.

The descriptions of system 200 apply to similar components of system 400. More specifically, the descriptions of system 200 can apply to similarly numbered components as grid 410, grid interconnect 420, inductor 422, capacitor 424, voltage measurement 426, current measurement 428, ISO 468, processor 460, communication (COMM) 462, grid compliance 464, waveform control 466, direction control 472, and waveform diagram 474.

System 400 includes a bridge circuit represented by switches with high voltage isolation (ISO) that are cross connected and coupled to the grid voltage and neutral. More specifically, the bridge circuit includes switch 432 coupled in series with switch 434 between the bridge high voltage and low voltage, where the high voltage signal is received in the node between the switches. The bridge circuit also includes switch 436 coupled in series with switch 438 between the bridge high voltage and low voltage, where the grid neutral signal is received in the node between the switches. System 400 includes a DC link represented by DC circuit 442 and capacitor 444. Processor 460 can measure the DC link high voltage signal and provide control signals to DC circuit 442. The descriptions of system 200 apply to similarly numbered components of system 400.

System 400 illustrates node 446 and node 448, which represent local interconnection points of the bidirectional energy transfer system. The components to the left of node 446 and node 448 can be considered the local application connected to the DC link. Node 446 can represent a connection point to a high voltage signal. Node 448 can represent a connection point to a low voltage signal.

System 400 illustrates an application that enables sourcing and loading power to one or more load or source components (load/source 490) within a consumer premises. The descriptions of system 300 can apply to similarly numbered components of system 400 with respect to the interconnection of the application to the DC link. More specifically, the descriptions of system 300 can apply to node 446, node 448, transformer 482, isolated switch 452, transformer 484, isolated switch 454, switch 486, switch 488, processor 460, and direction control 472. Instead of being coupled to top and bottom of battery, the descriptions can be understood as modified to refer to connecting to the top and bottom of load/source 490.

The application of system 400 represents that a storage device other than a battery could be used as a load and source. The application of system 400 can also apply to combinations of components, one or more that provide an energy source, and one or more that sink or load power from the grid or from other components in the consumer premises. In one example, system 400 can include one or more loads that require a step-down and can be powered from the DC link. In one example, system 400 can include one or more energy sources, such as renewable energy sources on the consumer premises.

As described above, processor 460 can control the switching of transformer 482 and transformer 484 in accordance with a desired flow of energy to/from the other component and load/source 490. Controlling the switching with direction control 472 enables system 400 to bidirectionally control the flow of energy, and the bridge circuit or the bridge circuit and the DC link can perform bidirectional waveform shaping of the energy flow between grid 410 and the application. In one example, an inverter can be included in the application of system 400 to connect to a load, and the switching of transformer 482 and transformer 484 can perform bidirectional waveform shaping of the energy flow between the source and the load or between the DC link and the load.

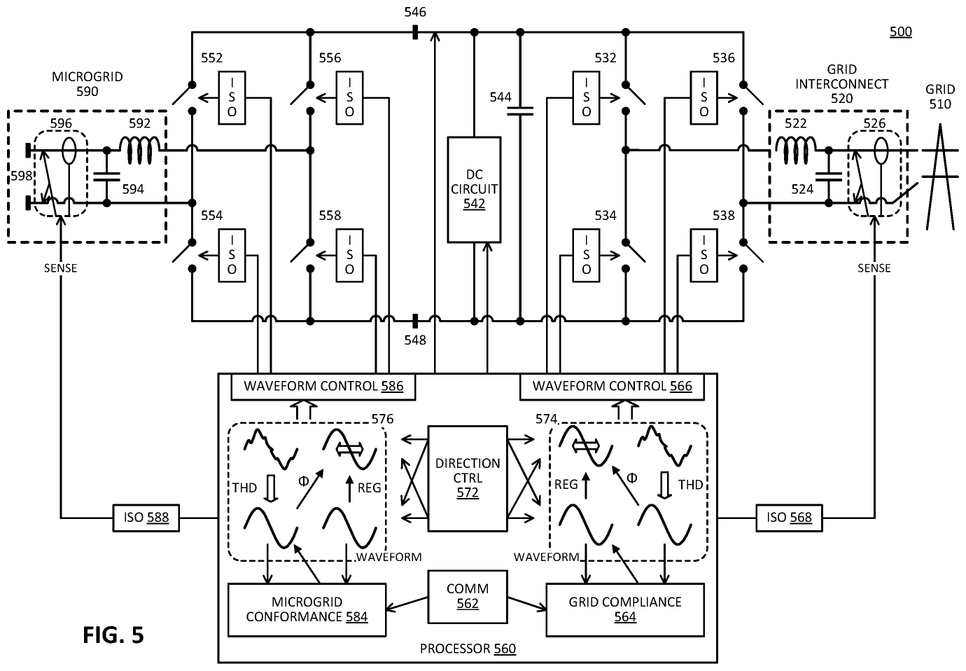

FIG. 5 illustrates an example of a bidirectional interconnection system with a microgrid. System 500 represents a system or a power transfer device or a power transfer system in accordance with an example of system 100 or an example of system 200. System 500 illustrates an application that provides a consumer-side or consumer-facing AC link, which enables a microgrid.

The descriptions of system 200 apply to similar components of system 500. More specifically, the descriptions of system 200 can apply to similarly numbered components as grid 510, grid interconnect 520, inductor 522, capacitor 524, ISO 568, processor 560, communication (COMM) 562, grid compliance 564, waveform control 566, direction control 572, and waveform diagram 574. Grid interconnect 520 illustrates both voltage measurement and current measurement together as measurement 526.

System 500 includes a bridge circuit represented by switches with high voltage isolation (ISO) that are cross connected and coupled to the grid voltage and neutral. More specifically, the bridge circuit includes switch 532 coupled in series with switch 534 between the bridge high voltage and low voltage, where the high voltage signal is received in the node between the switches. The bridge circuit also includes switch 536 coupled in series with switch 538 between the bridge high voltage and low voltage, where the grid neutral signal is received in the node between the switches. System 500 includes a DC link represented by DC circuit 542 and capacitor 544. Processor 560 can measure the DC link high voltage signal and provide control signals to DC circuit 542. The descriptions of system 200 apply to similarly numbered components of system 500.

System 500 illustrates node 546 and node 548, which represent local interconnection points of the bidirectional energy transfer system. The components to the left of node 546 and node 548 can be considered the local application connected to the DC link. Node 546 can represent a connection point to a high voltage signal. Node 548 can represent a connection point to a low voltage signal.

System 500 illustrates an application connected to node 546 and node 548 that is another bridge circuit. System 500 includes the same bridge circuit as previously described that will interconnect with grid 510. System 500 includes the other bridge circuit as an AC interconnect for a microgrid. System 500 includes a bridge circuit that is facing the grid or facing the utility and a bridge circuit that faces internally or faces the consumer side.

In the consumer-side facing bridge, the cross-connected switches are represented as control-signal isolated switches, with the switch and the ISO block. The ISO block represents switching control that is electrically isolated from the high voltage or high power path of the grid. Switch 556 and switch 558 are connected in series between the high voltage signal of node 546 and the low voltage signal of node 548, with the node between switch 556 and switch 558 connected to the high voltage microgrid line through inductor 592. Switch 552 and switch 554 are connected in series between the high voltage signal of node 546 and the low voltage signal of node 548, with the node between switch 552 and switch 554 connected to the low voltage microgrid line.

The second bridge circuit (or second H-bridge) is illustrated as having switching control managed by waveform control 586 of processor 560. Waveform control 586 is represented by diagram 576 within processor 560. The waveform with the angles and distorted line represents a waveform measured off the microgrid, with the measurement components. The THD represents total harmonic distortion control through the use of table-based or setpoint based idealized waveform generation. The idealized waveform is represented below the distorted waveform, and has no distortion.

The generated waveform can be an input to grid compliance components, represented by microgrid conformance 584, which can be the same or similar to grid compliance 564. Microgrid conformance 584 produces a desired waveform, which can be managed or regulated for phase (REG). The left and right arrow with the top right waveform represents the ability to set the phase angle (@) to any desired phase angle. Direction control 572 represents components that can perform computations and provide input to manage the angle of the generated waveform and the shape, amplitude, and frequency of the waveform based on whether power is provided by microgrid 590 or supplied to microgrid 590.

Microgrid conformance 584 can include settings that manage the switching of the AC interconnection bridge. The settings can be applied by the waveform generation hardware to generate the target waveform at the target phase. The target phase can be a phase that will put the generated current waveform in phase with the grid voltage for unity power factor, or at a desired offset with respect to the grid voltage to generate reactive power. By generating the waveform out of phase with respect to the grid voltage, system 500 can generate reactive power for reactive power injection into the consumer side of the system, independent of whether there is a reactive power connection to grid 510.

The settings can be preconfigured settings stored in processor 560 or in a memory device (not explicitly shown) accessible to processor 560. Preconfigured settings can include, for example, setpoints or table information with data for generating an output waveform. The settings can include settings computed in realtime by processor 560. The settings can include settings based on information provided by local sensors within system 500 (such as sensors that gather information monitored by a grid meter), by information provided by a gateway device, by information provided by grid management or dispatch information, or other information used to operate the hardware to shape the waveforms. COMM 562 can provide communication to microgrid conformance 584 as well as to grid compliance 564.

Whereas grid compliance 564 shapes the waveforms that allow AC interconnection to grid 510, microgrid conformance 584 shapes the waveforms that allow AC interconnection on the consumer side for microgrid 590. Microgrid conformance 584 can also have settings within it, or use information received from communication from a gateway or other source, or a combination of stored settings, computed settings, stored information, and received information.

Microgrid 590 is illustrated as having series inductor 592 in series in the high voltage signal line and capacitor 594 between the high voltage and low voltage lines. As with grid interconnect 520, the filter circuit of microgrid 590 can represent interconnect components that provide the ability to connect to a microgrid separate from grid 510. Microgrid 590 includes interconnects 598 to provide an interconnection for any type of application, such as load, source, battery, or any combination of these.

Measurement 596 represents current measurement and voltage measurement that can enable processor 560 to monitor the input and output of the microgrid. ISO 588 can represent electrical isolation of the measurement components from the high voltage or high power lines of the microgrid. The measurement can be made with one or more sensor components that sense microgrid conditions.

It will be understood that the waveform shaping on the microgrid side is not necessarily the same as the grid compliance. Thus, while system 500 includes two AC bridges, the separate bridges can operate independently. For example, one bridge can operate at unity power factor while the other generates reactive power by generating a waveform with a phase offset. Each bridge can operate on its own settings to provide the AC power for its interconnection. The DC link with DC circuit 542 provides the energy reservoir between the two AC bridges. The first AC bridge can provide bidirectional waveform shaping with respect to grid 510. The second AC bridge can provide bidirectional waveform shaping with respect to microgrid 590. It will be understood that referring to one of the AC bridges as the “first” and the other as the “second” is an arbitrary convention, and the labels can be reversed.

In one example, there is one hardware device that includes the first AC bridge and the DC link, and another hardware device with the second AC bridge. In one example, there is one hardware device that includes the first AC bridge and the second AC bridge. Thus, one hardware unit can include the grid interconnect and the application. In one example, multiple hardware units can be connected in series, having one hardware device connected directly to the utility grid, and another device connected to a microgrid to enable the connection of at least one other application to the microgrid.

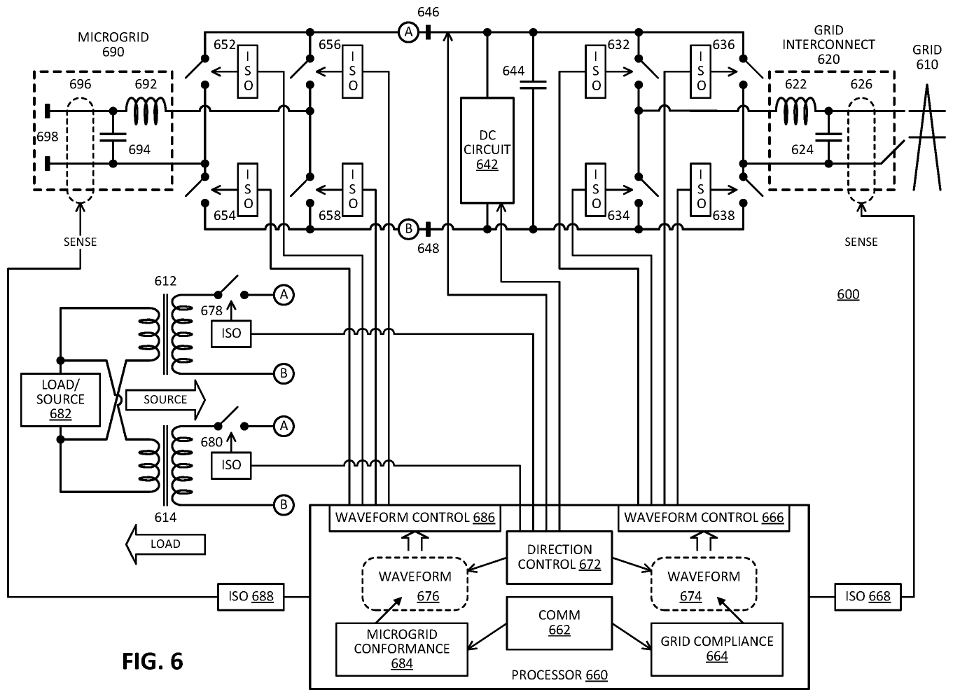

FIG. 6 illustrates an example of a bidirectional interconnection system with microgrid and a consumer application in parallel with the microgrid. System 600 represents a system or a power transfer device or a power transfer system in accordance with an example of system 100 or an example of system 200. System 600 more specifically illustrates an example with an AC application connected to the DC link through the AC bridge on the consumer side, as well as a load or source or battery as a DC application on the consumer side.

System 600 provides an example of a microgrid application in accordance with an example of microgrid 590 of system 500 connected in parallel to a load/source application in accordance with an example of load/source 490 of system 400. The descriptions with respect to system 500 apply to the components of system 600 that have similar reference numbers. More specifically, the descriptions of system 500 can apply to similarly numbered components as grid 610, grid interconnect 620, inductor 622, capacitor 624, measurement 626, ISO 668, processor 660, communication (COMM) 662, grid compliance 664, waveform control 666, direction control 672, waveform diagram 674, microgrid conformance 684, waveform control 686, waveform 676, one AC bridge with the isolated switches switch 632, switch 634, switch 636, switch 638, DC circuit 642, capacitor 644, node 646, node 648, another AC bridge with the isolated switches switch 652, switch 654, switch 656, switch 658, microgrid 690, inductor 692, capacitor 694, measurement 696, and microgrid interconnects 698. Measurement 696 can be electrically isolated, as illustrated by ISO 688.

In addition to microgrid 690, system 600 illustrates an application that enables sourcing and loading power to one or more load or source components (load/source 682) within a consumer premises. The descriptions of load/source 490 can apply to load/source 682, the descriptions of transformer 482 and transformer 484 can apply to transformer 612 and transformer 614, respectively, the descriptions of isolated switch 452 and isolated switch 454 can apply to isolated switch 678 and isolated switch 680, respectively.

As illustrated, direction control 672 can manage the direction of the DC application, whether sourcing energy or loading energy from the DC link interconnect. As described previously, energy can be exchanged between the different applications connected to the DC link interconnect connected through node 646 and node 648. Thus, the DC application can provide energy to the AC microgrid of microgrid 690, for example. The AC microgrid can enable the interconnection of a local AC source on the consumer side that is outside the control of utility grid 610.

System 600 illustrates one AC application and one DC application connected to the DC link. It will be understood that more than one AC application can be connected in system 600. Alternatively, or in addition, more than one DC application can be connected in system 600.

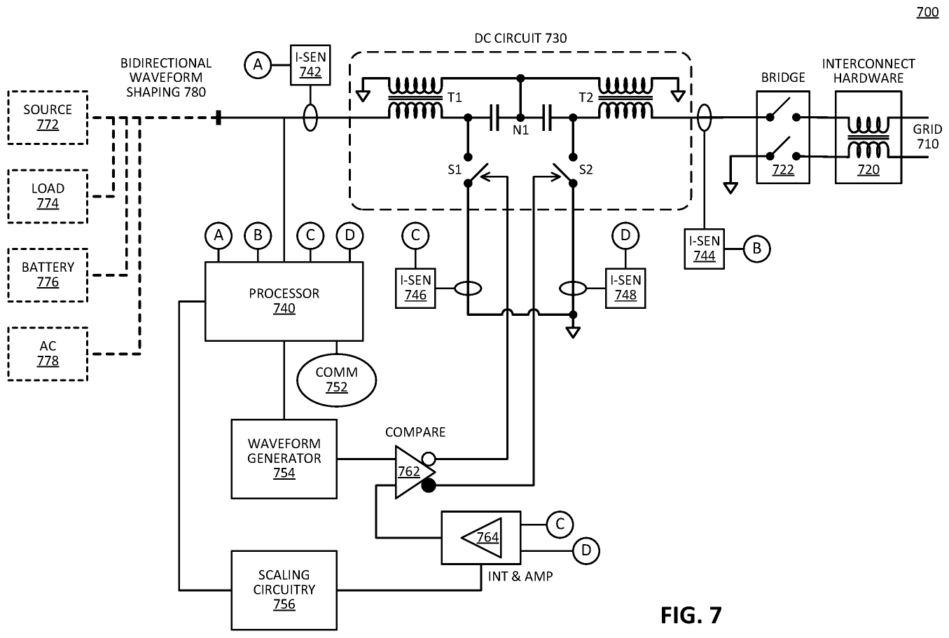

FIG. 7 illustrates an example of a system for bidirectional power transfer. System 700 represents a system in accordance with an example of system 100 or system 200. System 700 illustrates an example of the DC circuit and waveform control.

Processor 740, waveform generator 754, scaling circuitry 756, and comparison circuit 762 can be an example of power change analysis circuitry. System 700 can include integration (INT) and amplification (AMP) circuitry 764 as power change detection. The power change detection receives information from current sensors (I-SEN) to determine whether there is a change of power by detecting and integrating the signal information, detecting the difference, and providing an amplified signal for use by the comparison circuit. Scaling circuitry 756 is controlled by processor 740. Scaling circuitry 756 can provide a control signal to INT & AMP circuitry 764 to provide a scaled signal.

System 700 can include interconnect hardware 720 to couple to grid 710. Interconnect hardware 720 can provide an interconnection to bridge circuit 722 to grid 710. Bridge 722 can be in accordance with any description herein. Bridge 722 couples to DC circuit 730, which represents a DC link to an application for which system 700 provides bidirectional waveform shaping 780. Bidirectional waveform shaping 780 can be waveform shaping in accordance with any example herein.

System 700 includes power change detection to detect a power change of power at the DC link interconnection to the consumer application by monitoring the current at the internal node. The power change detection can trigger switching control through compare circuit 762. In one example, the power change detection circuitry detects a slope of the power change. Thus, the power detection can be referred to as slope detection. In one example, the power slope is an instantaneous power slope.

Compare circuit 762 can also receive an input from waveform generator 754. Waveform generator 754 can generate a signal such as a sawtooth wave, sine wave, triangle wave, or other waveform. Compare circuit 762 controls a duty cycle of the switches in DC circuit 730, represented as S1 on the consumer-facing side of internal node N1, and S2 on the grid-facing side of N1. In one example, the two switches are not both open or both closed at the same time. It is possible they are instantaneously both open or both closed during a transition when S1 and S2 are switching. Waveform generator 754 and compare circuit 762 provide switching control for DC circuit 730. In one example, processor 740 controls transformer T1 and transformer T2 with high-speed switching to convert an AC current waveform into a pseudo-DC current.

DC circuit 730 can provide an energy reservoir at N1. DC circuit 730 can represent power transfer circuitry to transfer power between the consumer side and the grid side. DC circuit 730 can include transformer T1 on the consumer side of N1 and transformer T2 on the grid side of N1. System 700 illustrates capacitors on either side of N1, with one capacitor connected in series between T1 and N1, and another capacitor connected in series between N1 and T2. The DC interconnection point is connected to a winding of T1, through the capacitor to N1. The AC interconnection point is connected to a winding of T2, through the capacitor to N1. The other winding of T1 can be connected between N1 and ground, while the other winding of T2 is also connected between N1 and ground.

When S1 is closed, electromagnetic fields change in T1 and T2 while the electrostatic potential across the capacitors changes, and energy can flow electromagnetically through T1 and T2, while energy changes electrostatically in the capacitors. When S1 opens, S2 closes and the magnetic flux in T1 begins to decrease. Thus, the energy stored in T1 flows through the capacitors, depositing energy as an electrostatic field into the capacitors, and depositing energy into T2 through node N1. The residual flux in T2 also begins to decrease, transferring energy into the grid-side bridge. When S1 closes and S2 opens again, the magnetic flux in T1 begins to increase while the magnetic flux T2 also increases as it consumes some of the electrostatic energy that was previously stored in the capacitors. Thus, energy stored in the DC circuit is discharged and transferred to T2 and to the bridge. By driving the switches at a proper frequency, T1 and T2 can be driven to saturation, resulting in an efficient transfer of energy between the grid side and the consumer side.

Multiphase energy transfer combines two or more phased inputs to produce a resultant flux in a magnetic core equivalent to the angular bisector of the inputs. It will be understood that an angle bisector of an angle refers to the locus of points equidistant from the two rays (half-lines) forming the angle. In system 700, the capacitors can shift the phase of the current that is applied to the secondary winding of T1 and T2 (the windings connected to ground). Thus, multi-phased inputs can be applied to the cores of T2 and T3. The summation of the multiphase inputs alters the electromotive force present during the increase and reduction of flux in the transformer's primary windings. The result is the neutralization (within the bandwidth of the operational frequency of the DC circuit) of high frequency variations in the reactive component of the impedance that the transformer circuits would normally exhibit to the consumer side and the grid side. The DC circuit can include multiphase bisector energy transfer circuits to cause the multiphase bisector energy transfer and to interface with N1.

The power change detection, power change indication, and the compare circuitry (compare circuit 762) can provide a control loop that controls the duty cycle of the switching of DC circuit 730 to cause saturation of the transformers and cause the desired flow of energy through DC circuit 730. In one example, the frequency of switching can be within a range of approximately 100 kHz to 250 kHz, and will depend on the size and properties of the transformers and their associated core materials.

Processor 740 can be or include a microprocessor, microcontroller, ASIC (application specific integrated circuit), FPGA (field programmable gate array), or a combination. The current sensors in system 700 can provide feedback regarding the change in current flow to processor 740. System 700 illustrates four current sensors that produce current sensing signals A, B, C, and D. More specifically, system 700 includes I-SEN 742 can sense current on the consumer side of DC circuit 730 as signal A, I-SEN 744 can sense current on the grid side of DC circuit 730 as signal B, I-SEN 746 can sense current on S1 as signal C, and I-SEN 748 can sense current on S2 as signal D.

Processor 740 can receive signals indicative of the sensed current as well as voltage on the node at the interconnection point of the application to DC link 730. In one example, processor 740 gathers information about sub-loads or specific loads rather than all connections as an aggregate. In one example, processor 740 provides control to sub-loads or sub-components. The current information can be used to indicate information such as the rate, amount, and efficiency of power transfer.

One reason to gather such information is for processor 740 to determine whether to be in a protection mode or an ordinary operating mode. In the protection mode, processor 740 can perform various operations to provide protection for system 700. One option is to open both switches S1 and S2. Another option is to provide a bias signal to scaling circuitry 756 to adjust the switching control signal for compare circuit 762. For example, if the bias signal causes the switching control signal to be very high, the duty cycle would be low, causing the current to be small. The regulation of power in the protection mode can be to completely shut off the power or merely to reduce the power. In the protection mode, system 700 could aim to reduce power transfer rather than maximize the efficiency of power transfer. In some examples, the bias signal can be asserted for purposes other than merely protection mode.

Additionally, when the current sensors provide signals indicative of the current through switches S1 and S2, the power can be related to an average current of the combined signals. The integration and amplification can include an integrator to provide a signal indicative of the power, which is differentiated and amplified within the integration and amplification circuitry 764.

DC circuit 730 represented in system 700 will be understood as a simplified diagram that illustrates an example of the circuitry that can provide an energy transfer point between the consumer side and the grid side, or between different applications on the consumer side. System 700 represents different options for consumer-side applications. In one example, system 700 includes source 772 on the consumer application, which will provide energy into the DC circuitry. In one example, system 700 includes load 774 on the consumer application, which will consume energy from the DC circuitry. In one example, system 700 includes battery 776 or other storage device on the consumer application, which can consume energy (charge) or provide energy (discharge) to the DC circuitry. In one example, system 700 includes AC consumer application, AC 778, which can provide a decoupled AC microgrid.

Whatever the consumer application, system 700 illustrates that the interconnection to DC circuit 730 can provide bidirectional waveform shaping 780 between the consumer application and grid 710. The bidirectional waveform shaping can be in accordance with any example provided herein. The specific control from the processor or other control components is not specifically shown in system 700.

DC circuit 730 can be modified with different components, such as additional resistors, capacitors, inductors, or other components. The modifications can provide additional current paths to ground, can adjust the voltages across the transformer windings or across the central internal node, or other modifications. The modifications can add storage components in the central node or add other internal nodes for energy storage.

Communication (COMM) 752 represents an input to processor 740 to provide communication from outside the grid interconnect hardware. In one example, COMM 752 represents dispatch signals from the utility that manages grid 710. In one example, COMM 752 represents communication from other grid interconnect hardware, whether in a hierarchical system, or simply within a common customer premises.

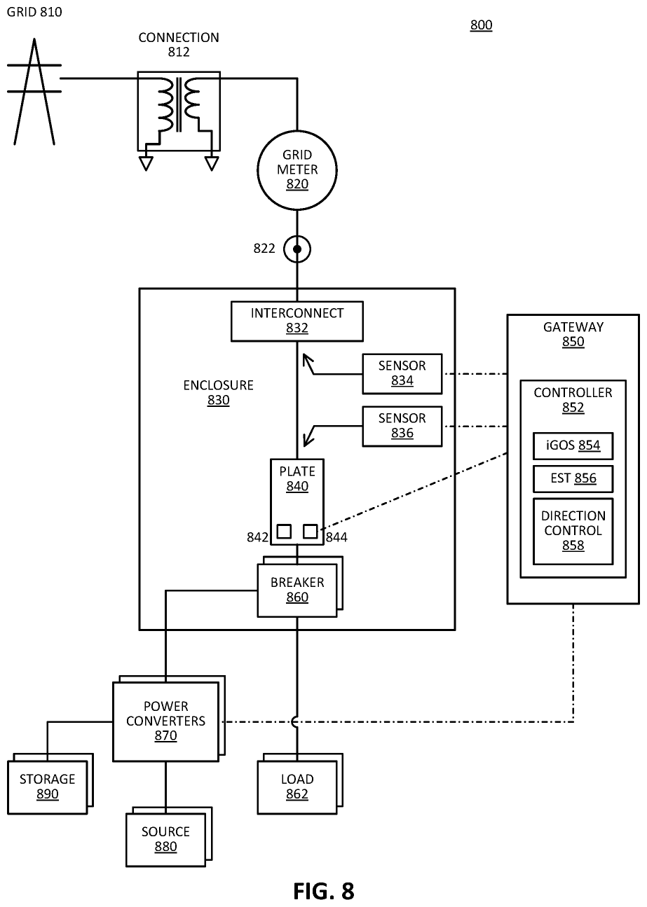

FIG. 8 is a block diagram of an example of a system with bidirectional power transfer based on measuring by internal current sensors. System 800 provides an example of a power system. System 700 represents a system in accordance with an example of system 100 or system 200.

Grid 810 represents a utility grid that provides power to consumer premises from one or more grid-managed generators, which may include distributed generators. Connection 812 represents a substation or power transformer or other infrastructure to step down the very high voltage transmission line of grid 810 to a consumer high voltage (e.g., 120 V, 220 V).

Grid meter 820 represents a grid meter, which monitors power delivery to a customer premises to charge the customer for the power delivery. The utility charges the consumer based on measurements made by grid meter 820 to monitor power delivered from grid 810 to the consumer premises through point of common coupling (PCC) 822.

Enclosure 830 represents an electrical enclosure at the consumer premises. Interconnect 832 represents a connection circuit to receive the utility connection. In one example, interconnect 832 can be a simple transmission line connection. Alternatively, interconnect 832 can include isolation hardware or other circuitry.

Plate 840 of enclosure 830 represents an electrical conductor to provide grid power to multiple circuit breakers represented by breakers 860. Breakers 860 represent any number of circuit breakers that can be included in enclosure 830. In one example, enclosure 830 includes sensor 842 and sensor 844 to measure currents for electrical circuits provided by breakers 860. In one example, sensor 842 and sensor 844 can provide four-quadrant measurement of power for the connection to the utility. Thus, sensor 842 and sensor 844 can provide measurements similar to a meter, and can be referred to as internal meters, separate from grid meter 820 used to charge the customer. The internal meters enable system 800 to track the energy usage by the customer premises to adjust operation within PCC 822 (behind the meter relative to grid meter 820) to change the flow of energy at PCC 822.

In one example, enclosure 830 includes sensor 834 to monitor the connection to grid 810. Sensor 834 can be referred to as grid facing, as it measures the current waveforms as seen looking into the grid connection. In one example, enclosure 830 includes sensor 836 to monitor the connection to the electrical components of the consumer premises. Thus, sensor 836 can be said to be consumer facing, as it measures the current waveforms as seen looking into the local system at the consumer premises. In one example, there are multiple consumer facing sensors 836. Sensor 834 and sensor 836 could be referred to as meters in the sense that they monitor the power use at the consumer premises. However, they are understood to be separate from grid meter 820. Additionally, whereas grid meter 820 generally tracks measurements used to determine power usage, sensors 834 and 836 can be used to generate current waveform data. The current waveform data can enable system 800 to operate in different current zones based on comparison of the local current waveform with the grid waveform.

System 800 includes loads 862, which represent the local loads at the consumer premises. The loads are any devices (e.g., lights, heating, air conditioning, refrigeration, electronics, or others) that consume electricity to operate. Source 880 represents any energy generation device, which is a device that generates energy as it operates, such as solar or wind generators. Storage 890 represents a device that stores energy to be usable in a time-delayed manner, such as a battery.

In one example, system 800 includes power converters 870, which represent power converters in accordance with any example described. More specifically, power converters 870 represent power converters that can perform bidirectional waveform shaping in accordance with any example herein. Power converters 870 can represent microinverters in accordance with any example herein. In one example, each storage device 890 has at least one associated power converter 870. In one example, each source 880 has at least one associated power converter 870. In one example, power converters 870 provide energy back into enclosure 830 to be distributed to one or more circuits of breaker 860.

In one example, system 800 includes gateway 850 to manage power usage at the consumer premises. In one example, some or all of gateway 850 is incorporated into enclosure 830. In one example, gateway 850 has a separate electrical box communicatively coupled to components of enclosure 830. Gateway 850 includes at least one processor device, represented by controller 852. In one example, controller 852 represents an embedded computer. Controller 852 performs computations to generate current waveforms and performs computations to determine how to control operation behind the meter at the consumer premises to control what power consumption is seen at PCC 822 by grid meter 820.

Controller 852 represents hardware to execute intelligent grid operating system (iGOS) 854. iGOS 854 represents a control system for enclosure 830 and power converters 870. In one example, controller 852, through iGOS 854, executes EST computations, represented by EST 856. Through iGOS 854, gateway 850, sensor 834, sensor 836, and power converters 870 can represent a control node that can provide energy services(ES), energy transactions (ET), energy services transactions (EST), or a combination of ES, ET, and EST.

The control architecture includes energy services(ES) (such Apparent Energy Services (AES)) as a control framework within a specific control node for a specific consumer premises, energy transactions (ET) (such as Apparent Energy Transactions (AET)) as a control framework within a subnet or neighborhood between different consumer premises, and energy services transactions (EST) (such as Apparent Energy Services Transactions (AEST)) as a communication/documentation framework for interaction between control points. The control points can be within a consumer premises or between different consumer premises.

ES allows a control point within a single unit or single component within a consumer premises to perform energy audits, manage the local operation of hardware, software, and compliance in changing regulatory environments, and perform verification and transmittal of timely data inside and outside of the local network. The control node within each consumer premises can represent one or multiple control points. In one example, the control node is the control point for the grid network.

The local network includes hardware components within PCC 822 or behind the meter, specifically, behind grid meter 820. The local network can refer to everything downstream from the control point. A control point executes an ES service provider, which provides the core of EST because it provides realtime data and live control over individual nodes in the network. The nodes operate independently of each other, but can receive and respond to data from peers. The ES provides a primary building block to the system to enable the full integration of renewable resources into the grid as aggregated, distributed resources.

At its most basic level, ES provides an engine for the control point to monitor and control the operation of the local node, which can provide energy savings for the consumer premises. The control point typically monitors a customer, or a portion of a consumer premises. A consumer premises can include a building structure, ventilation (heating and cooling) unit, lighting, electric appliances, motors, pumps, or other consumer that is charged by the utility for energy consumption. Some consumer premises can include an EV charging station.

ES operates based on realtime data generated within the system, and based on the ability to generate reactive power to perform reactive power injection of energy into a measured point. ES operation is flexible and dynamically upgradeable. ES technology enables the control nodes to make energy use decisions solution-oriented in that they can be driven to address a specific need at the consumer or within the grid. ES makes energy use decisions customer-oriented in that they can be driven by specific decisions to maximize the economic use of the customer system. ES makes energy use a value-creation proposition in that they can be driven to address a specific need at the consumer or within the grid, which can stabilize the grid while providing the economic benefits a customer expects from a solar system.

ET enables nodes within a subnet to share information about the availability of services at specific nodes and energy needs at specific nodes within a subnet. Energy consumers have become energy prosumers, which are traditionally prevented from participation in the open energy market. In fact, the current market participants set the rules for prosumers, defining how much they can be paid, and when they can be paid. The energy market can only exist because of the consumers; thus, prosumers are part of the very group that provides financial credibility to the market.

EST enables a consumer energy system to provide value to the market. Rather than setting the consumer against the market operators, the consumer system with the control nodes described can benefit the stability of the power grid. EST provides the tools to enable the interaction among different nodes within a subnet. Additionally, EST can enable sharing of information between subnets.

Currently, power grids can include multiple prosumers, with the utility having no realtime knowledge of the existing prosumers and the energy production they can provide. In traditional systems, the utility will operate based only on what has already happened at the consumer premises and what the capabilities of market participants are. Without realtime data on prosumers, grid 810 not only does not plan or take into account the energy produced or consumed by the prosumers, but in fact cannot account for the controllable effects prosumers can have on the grid.

With EST, control nodes can share information as part of a process that leads to energy production, management, and energy efficiency based on peer nodes. The sharing of data among peer nodes identifies a fundamental concept that traditional prosumer systems and even current energy markets do not recognize: the value of energy changes over time and distance. EST enables prosumer nodes to account for the fact that energy consumed close to production has fewer losses, and energy consumed locally on demand can maximize the benefit of the energy production by addressing local energy needs and market stability with immediately available energy. Fast response to energy needs with local energy is expected to significantly improve grid stability because what leads to grid instabilities is imbalance between energy need and energy availability over time.

Generating energy at a central source of a power plant of the grid and moving it many miles is very inefficient relative to generating the energy close to where it is needed. Distributed generation systems provide benefits over central power plants, but distributable generation at the points of consumption can provide benefits not achievable by traditional grid architectures. EST enables the control nodes of system 100 to share information related to need and capabilities to provide distributable generation through consumer DERs.

The EST information essentially turns energy generation and consumption into realtime grid data. The EST data can identify where needs and generation are relative to each other. With EST, the prosumer systems can adapt operation to adjust for the actual local conditions at the consumer node in light of electrical conditions of the grid at the PCC of the consumer node to the grid.

EST 856 represents computations that can be performed for source 880, load 862, storage 890, and power converters 870, in any combination. Thus, EST 856 represents the ability of gateway 850 to utilize EST information to determine how to interact with grid 810. System 800 does not illustrate other consumer nodes, but other nodes similar to the consumer premises of system 800 can exchange and consume EST information in accordance with any example herein. The sharing and use of EST information among consumers enables truly distributed energy generation with truly distributed grid intelligence.

The dashed lines illustrate communication in system 800. In one example, gateway 850 or controller 852 receives sensor data from sensor 834 to provide grid conditions and sensor data from sensor 836 to provide local conditions. In one example, gateway 850 or controller 852 receives information from sensors 842 and 844 to indicate current information for various specific electrical circuits in the consumer premises. In one example, gateway 850 or controller 852 provides one or more commands to one or more power converters 870 to change operation of the selected power converters. The change in operation of the selected power converters can change the consumption of power as seen from the grid side. The change in operation can generate reactive energy to inject into the electrical circuits to satisfy reactive power demand, or to inject reactive power out to grid 810.

In one example, controller 852 computes a quadrant of operation of the current waveform for the local system. Controller 852 can compute a desired quadrant of operation for the local current waveform based on a quadrant of operation of the current waveform for the grid. If the current waveform for the local system is not the desired operation, the controller can send one or more commands to power converters 870 to adjust operation. Power converters 870 can adjust a mix of real and reactive power to shift the local current waveform into the desired quadrant of operation. In one example, the power converters simply convert more real power into reactive power. In one example, the power converters convert more generated energy from source 880 into reactive energy to inject back into the system. In one example, the power converters convert stored energy from storage 890 into a mix of real and reactive energy to inject back into the system. Any of these actions or a combination of these actions can change the operation of the local current waveform to the desired quadrant.

Based on the various computations, controller 852 can determine a direction for one or more power converters 870 that provide bidirectional waveform shaping. Direction control 858 represents the determination and control to provide to one or more power converters 870 to determine how they interface with power from breakers 860 from grid 810. One or more power converters 870 can have an AC bridge to interface with grid power through breakers 860.

In one example, one or more loads 862 (e.g., an air conditioner) can have a power converter 870 to manage the power consumption of a particular load. For example, certain loads 862 have a high reactive power demand. In one example, power converter 870 can draw real power from grid 810 and convert the real power locally into reactive power. Thus, rather than changing the reactive loading of the consumer premises as traditionally done, power converter 870 can draw only real power from the grid, which is electrically isolated from its output. Thus, grid meter 820 will see only real power draw by the consumer premises. However, the electrical isolation of power converter 870 between its input and output can provide a local reactive power output to satisfy the demands of a specific load 862. Thus, a reactive load can appear to the grid to draw only real power. Thus, although the connection lines go from load 862 to breakers 860, in one example, at least one load 862 could be coupled to breaker 860 through power converter 870.

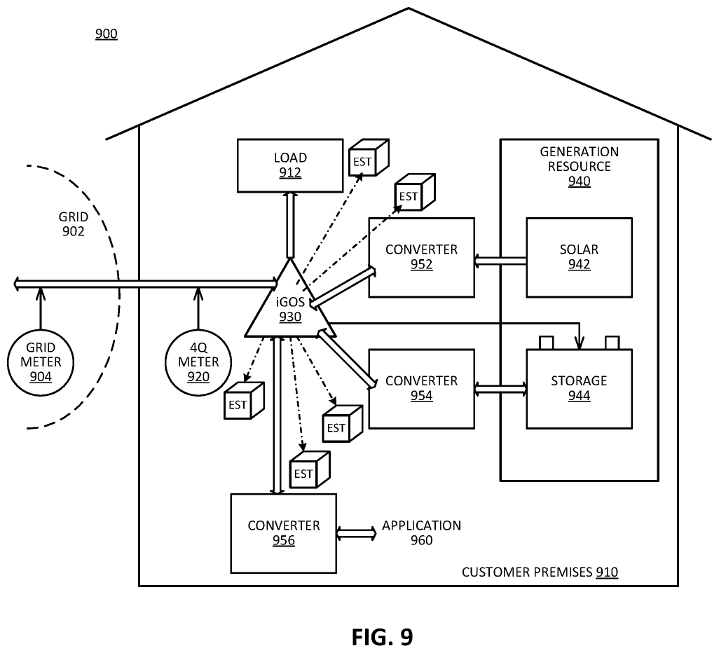

FIG. 9 is a block diagram of an example of a consumer node with bidirectional power transfer. Customer premises 910 represents a grid consumer, and includes energy generation resources 940. Customer premises 910 represents a grid prosumer. Generation resources 940 can include any type of generator or renewable resource such as solar system 942. In one example, generation resources 940 include storage 944, which can store energy for later retrieval.

Customer premises 910 includes load 912, which can represent one or more individual loads for the premises, or can represent the entire customer premises. Load 912 can have a particular harmonic signature. In one example, customer premises 910 includes iGOS 930, which represents an intelligent platform for energy management of energy generated and consumed at customer premises 910. iGOS 930 can be in accordance with any example described herein. In one example, customer premises 910 interfaces with grid 902 via hardware interconnect resources, and grid meter 904 can monitor the connection. Grid meter 904 is the meter used by the grid to monitor net power delivered to customer premises 910 to charge the consumer for power.

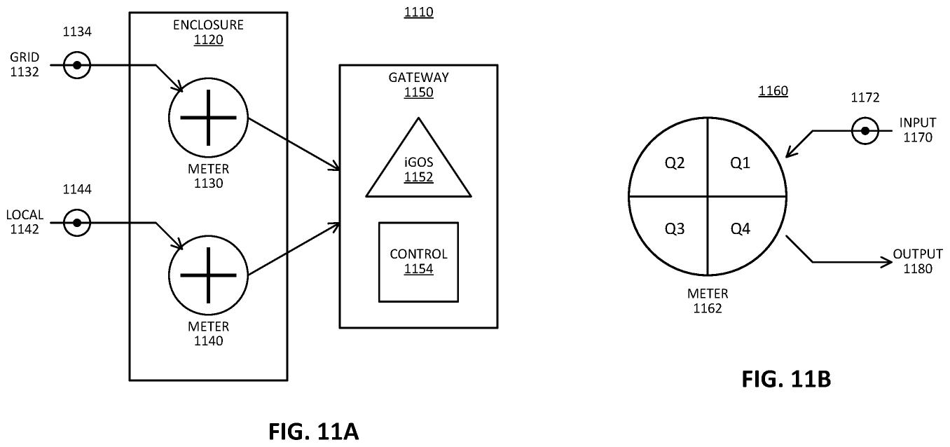

In one example, customer premises 910 includes an internal meter, represented by 4Q (four quadrant) meter 920. As a four quadrant meter, meter 920 can indicate not only the quantity of real and reactive power, but in what quadrant the operation currently is. More details regarding the four quadrant meter operation are provided below with respect to FIG. 11A and FIG. 11B.

In one example, solar 942 provides its power for available use by load 912 or to export to grid 902 via converter 952. Converter 952 represents a microinverter that can provide on-demand reactive power from a real power source. Thus, while solar 942 outputs DC power, converter 952 can provide AC output with any phase between the output voltage and current, by driving the current based on a reference waveform, and allowing the voltage to follow the current. Converter 952 can provide waveform shaping of the power output from solar 942. Converter 952 has electrical isolation between the input and output, and the electrical isolation allows the device to impedance match both input and output by simply transferring energy between the input and output, instead of regulating a specific voltage or current.

In one example, converter 954 represents a microinverter that can provide on-demand reactive power from a real power source. In one example, the descriptions of converter 952 can apply to converter 954. In one example, converter 954 provides bidirectional waveform shaping for the power interface to storage 944. In one example, storage 944 will include a separate converter to provide DC power to charge the battery.

In one example, customer premises 910 includes converter 956 to provide bidirectional waveform shaping for application 960. Application 960 can be in accordance with any application described. In one example, application 960 represents an AC application, where converter 956 can provide bidirectional waveform shaping for a microgrid of customer premises 910. The microgrid can be for selected loads and power generation of customer premises 910. In one example where converter 956 provides a microgrid, converter 952, converter 954, generation resource 940, and load 912 can all be behind converter 956 as part of the microgrid. iGOS 930 can monitor the bidirectional energy transfer of converter 956 with EST computations.

Customer premises 910 illustrates three components of an intelligent platform for energy management. The first is iGOS 930 to monitor, analyze, and regulate fluctuations of energy use. The next is a converter to manage and modulate voltages and frequencies, and communicate the information multilaterally to consumers, grid operators, and utilities. The converters are capable of reactive power generation, as has previously been stated. The third includes meter 920 and iGOS 930 to perform data collection to aggregate all information from multiple sources to increase overall system intelligence and reliability. In one example, the overall aggregated information occurs only at the control center. When operating together, system 900 can provide the smartest energy decisions for the end-user at any given time, whether it is to increase renewable energy generation, reduce energy consumption, delay use of grid-delivered energy, sell excess energy to the grid, or other decision, or any combination of decisions.

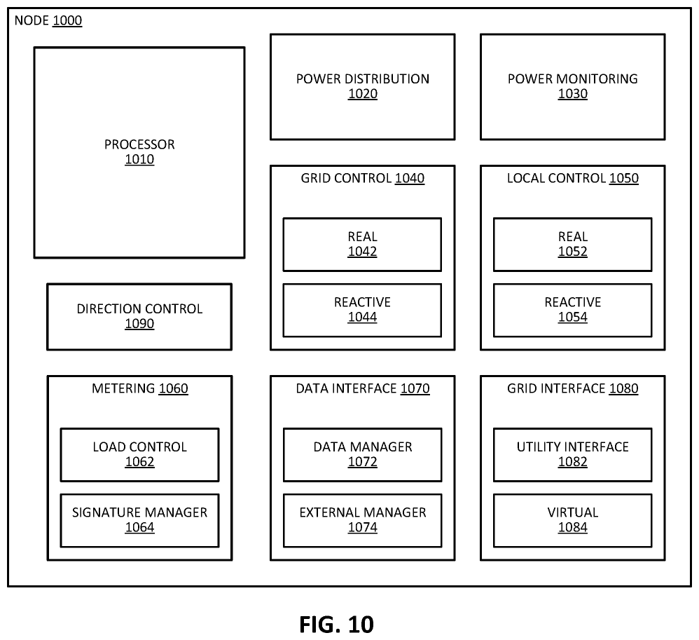

FIG. 10 is a block diagram of an example of a DER node for a bidirectional distributed power. Node 1000 represents a DER node, which can be a customer premises. Node 1000 includes various hardware elements to enable its operation. In general, the hardware can be described as processor 1010, power distribution hardware 1020, and power monitoring hardware 1030. Each of these elements can include specific types and functionality of hardware, some of which can be represented by other elements of node 1000.

Processor 1010 represents one or more controllers or processors within node 1000. In one example, node 1000 includes a power meter, a power converter, and control hardware to interface the two elements and couple to the grid. In one example, each separate item includes a controller, such as a controller within the metering device, and a controller within the power converter. The power converter can include a power extractor controller, an inverter controller, a bidirectional grid interconnect controller, and another controller to manage them. Thus, processor 1010 can represent one or more controllers, CPUs (central processing units), processors, or other elements of control logic that enables node 1000 to monitor and distribute power.

Processor 1010 manages and controls the operation of hardware within node 1000, including any hardware mentioned above. Processor 1010 can execute to provide iGOS for node 1000. In one example, processor 1010 executes logic to provide at least some of the functions described with respect to node 1000. To the extent that functions described are provided by hardware, processor 1010 can be considered a controller to control the operation of the hardware. In one example, processor 1010 executes a DER node operating system for node 1000. In one example, the operating system is iGOS.

The iGOS platform can provide computing, and general control over the operation of node 1000. In one example, iGOS enables the node to collect data and make decisions to send data outside the node. In one example, iGOS can use the data to control the local system, such as the local elements coupled to a same side of a PCC. In one example, iGOS also sends data for use by external entities, such as a utility manager or other nodes in the grid network.

In one example, iGOS controls dispatch functionality for node 1000. The dispatching can include providing and receiving data and especially alerts used to determine how to distribute power. In one example, the iGOS can enable autonomous dispatching, which allows the nodes of the grid network to share information among themselves that control the operation of the grid. The autonomous dispatching refers to the fact that a central grid operator does not need to be involved in generating or distributing the dispatch information.

In one example, iGOS enables control functionality. The control can be by human, cloud, or automated control logic. In one example, the iGOS enables node 1000 to work independently as an individual node or work in aggregate with other DER nodes in a grid network. The independent operation of each can enable the distributed network to function without a central power plant, or with minimal central grid management.

In one example, the iGOS can enable blackstart operation. Blackstart operation is where node 1000 can bring its segment of the grid back up online from an offline state. Such operation can occur autonomously from central grid management, such as by each node 1000 of a grid network independently monitoring conditions upstream and downstream in the grid network. Thus, node 1000 can come online when conditions permit, without having to wait for a grid operator to control distribution of power down to the node. Node 1000 can thus intelligently bring its node segment back up online by controlling flow of power to and from the grid, and can thus, prevent startup issues. In one example, iGOS enables virtual non-export operation. Non-export includes not outputting power onto the grid. However, with the iGOS, node 1000 can convert real power to reactive power, and continue to export power, but not of a type requested by the grid, instead of simply dumping watts onto the grid.

In one example, the iGOS enables node 1000 to offer multiple line voltages. In one example, grid interface 1080, which may be through control logic of processor 1010, can be configured for multiple different trip point voltages. Each trip point voltage can provide a different control event. Each control event can cause processor 1010 to perform control operations to adjust an interface of the DER node. The interface can be an interface to a load and/or an interface to the grid network.

In one example, the iGOS can economize interconnects within the grid network. In one example, node 1000 controls backflow (e.g., through non-export) onto the grid network by limiting the backflow, or adjusting output to change a type of power presented to the grid. In one example, node 1000 provides utility control functions that are traditionally performed by utility grid management that controls flow of power from a central power plant. Node 1000 can provide the grid control functions to enable a distributed power grid.

Power distribution hardware 1020 includes power lines, connectors, phase locked loops, error correction loops, interface protection or isolation such as transformers, or other hardware or a combination that enables the DER node to transfer energy from one point to another, to control interfaces to control how power flows throughout the grid, or other operations. In one example, power distribution 1020 can include a power converter. A power converter can be a smart inverter or microinverter. In one example, power distribution 1020 can include bidirectional grid interconnect or power transfer system with bidirectional waveform shaping in accordance with any example herein.

Power monitoring hardware 1030 includes connectors, signal lines, sampling hardware, feedback loops, computation hardware, or other hardware that enables the DER node to monitor one or more grid conditions or load conditions or both. The grid conditions can be or include voltage levels, phases, frequencies, and other parameters of the grid operation. The load conditions can be or include voltage, current, phase, frequency, and other parameters of power demand from loads.

In one example, node 1000 includes grid control 1040. Grid control represents hardware and logic (e.g., such as software/firmware logic, configurations) to control an interface to the grid network. In one example, grid interface 1080 represents grid network interfaces. Grid control 1040 can include real power control 1042 and reactive power control 1044. The real and reactive control can be in accordance with any example described herein. In one example, real power control 1042 includes logic (hardware or software or a combination of hardware and software) to provide real power to the grid. In one example, reactive power control 1044 includes logic to provide reactive power to the grid. Providing power to the grid can include changing an interface to cause power of the type and mix desired to flow to the grid.

In one example, node 1000 includes local control 1050. Local control represents hardware and logic (e.g., such as software/firmware logic, configurations) to control an interface to the load or to items downstream from a PCC coupled to a grid network. Local control 1050 can include real power control 1052 and reactive power control 1054. The real and reactive control can be in accordance with any example described herein. In one example, real power control 1052 includes logic (hardware or software or a combination of hardware and software) to provide real power to a load. In one example, reactive power control 1054 includes logic to provide reactive power to a load. Providing power to the load can include changing an interface to cause power of the type and mix desired to flow to the load from a local energy source and/or from the grid.

It will be understood that a utility power grid has rate structures that are based on not just the amount of use, but the time of use. For example, a utility grid can have tiered rates. In one example, processor 1010 includes rate structure information that enables it to factor in rate structure information when making calculations about how to change an interface with grid control 1040 or with local control 1050. Factoring in rate structure information can include determining what type of power (real or reactive) has more value in a given circumstance. Thus, processor 1010 can maximize value of energy production or minimize the cost of energy consumption. In an implementation where tiered rate structures exist, processor 1010 can instruct grid control 1040 or local control 1050 based on how to keep consumption to the lowest tier possible, and how to provide power at a highest rate possible. In one example, processor 1010 takes into account utility or grid network requirements when controlling the operation of grid control 1040 or local control 1050. For example, the grid may have curtailments or other conditions that affect how power should be provided or consumed. In one example, node 1000 can adjust power output as loads dynamically come online and offline. For example, local control 1050 can reduce output when loads go offline, and can increase output when load come online.

Metering 1060 represents metering capability of node 1000, and can include an internal meter or a consumer meter behind the grid meter in accordance with any example described herein. In one example, metering 1060 can include load control metering 1062. Load control 1062 can include logic to monitor load power demand. In one example, metering 1060 can include signature manager 1064. Signature manager 1064 includes logic to create, store, and use energy signatures in monitoring what is happening with loads. More specifically, signature manager 1064 can manage energy signatures including complex current vectors in accordance with any example described herein.

Traditionally, a net energy meter was required to connect to the grid. However, newer regulations may prevent connecting to the grid at all unless certain capabilities are met. Metering 1060 can enable node 1000 to control an inverter or converter to respond to specific loads or to specific energy signatures identified on the line. Based on what metering 1060 detects, node 1000 can provide realtime control over energy production and load consumption.

In one example, node 1000 includes data interface 1070. In one example, data interface 1070 includes data manager 1072 to control data that will be sent to a data center or data management, and data that is received from the data center or data management. Data manager 1072 can gather data by making a request to a data center or comparable source of data. In one example, data interface 1070 includes external manager 1074, which can manage the interface with a data center, central grid management, other nodes in the grid network, or other data sources. In one example, data manager 1072 receives data in response to data sent from a data source. In one example, external manager 1074 makes a request for data from a data source. The request can be in accordance with any of a number of standard communication protocols or proprietary protocols. The medium for communication can be any medium that communicatively couple node 1000 and the data source. In one example, external manager 1074 communicates with a data source at regular intervals. In one example, external manager 1074 communicates with the data source in response to an event, such as more data becoming available, whether receiving indication of external data becoming available, or whether data manager 1072 indicates that local data is ready to send. Data interface 1070 can enable realtime data for market use. In one example, data interface 1070 provides data collection, which can be used in one example to identify currents for energy signatures.

In one example, node 1000 includes grid interface 1080. In one example, grid interface 1080 includes utility interface 1082 to interface with a utility grid. In one example, grid interface 1080 includes virtual interface 1084 to interface with a distributed grid network. The operation of the grid interface can be referred to as MGI (modern grid intelligence), referring to execution of an MGIOS by processor 1010. Grid interface 1080 can include any type of interface that couples node 1000 to grid infrastructure, whether traditional utility grid infrastructure or distributed grid networks. In one example, grid interface 1080 can enable node 1000 to know a power direction. In one example, the grid network provides dispatch information, such as provide a signal from a feeder to indicate a power direction. Node 1000 can manage its operation based on the direction of power flow in the grid network. Grid interface 1080 can also dynamically monitor changes in direction of power flow.

In one example, the iGOS enables node 1000 to adjust operation of one or more elements connected downstream from a PCC, to scale back operation of the grid. Consider an example of air conditioners coupled downstream from a PCC. In one example, the iGOS can detect that the grid network is experiencing heavy load, and can determine to slow down all air conditioners to relieve the grid for 5 to 10 minutes. Thus, the devices do not need to be stopped, and the grid does not need to shut off power to any segment. Instead, the power can be reduced for a period of time to selected loads to allow the grid can recover itself. Thus, the iGOS can control the load or the sources. Such operation can reduce or prevent brownouts or rolling blackouts, for example, by scaling power demand back instead of completely shutting supply down.

It will be understood that node 1000 requires a certain amount of power to operate. The power consumed by node 1000 can be referred to as tare loss, which indicates how much power the controlling devices consume when the node is not generating power. In one example, node 1000 includes a sleep feature to reduce tare loss. For example, a node that controls a metastable energy source such as solar can sleep when there is no sun, and can wake up when the sun comes up. In one example, the node can default to a low power state and awake in response to a signal from a solar detector, power over Ethernet, or some other external signal trigger to wake it up. In one example, a node can wake up during a sleep cycle at night to perform upgrades or perform other ancillary services.

In one example, node 1000 can perform EST operations and EST control. In one example, node 1000 includes direction control 1090. Direction control 1090 represents the ability of node 1000 to determine a direction of power flow for power distribution 1020 or other hardware. In one example, direction control 1090 represents a direction determination for reactive power. In one example, direction control 1090 represents a direction determination for real power. In one example, direction control 1090 represents a direction determination for a combination of real power and reactive power.

FIG. 11A is a block diagram of an example of an enclosure with multiple meters. System 1110 represents a system in accordance with system 800. System 1110 includes enclosure 1120 with meter 1130 and meter 1140. System 1110 also includes gateway 1150. The information of system 1110 can be used by a control node for EST computations in accordance with any example described. System 1110 can provide control for bidirectional waveform shaping in accordance with any example described.

Enclosure 1120 can include electrical distribution hardware for a consumer premises, in accordance with what is described above. It will be understood that meter 1130 and meter 1140 are labeled as meters for simplicity in description, but may not be considered meters in the traditional sense that they do not monitor power usage for charging a consumer. In one example, meter 1130 and meter 1140 do not measure power consumption in the same sense as a utility power meter. In one example, meter 1130 and meter 1140 sense data to compute current vectors to represent the conditions, respectively, of the grid and of the local system.

In one example, meter 1130 generates data readings of the current of grid 1132 as seen looking into PCC 1134, which is the connection point of the consumer premises to the grid. Based on the data readings, a controller can calculate a current vector for the current as seen at PCC 1134. The current vector has a magnitude and a direction, which in one example is mapped onto a 4-quadrant unit circle. The mapping of the current vector onto the unit circle can identify a combination of real (x-axis) and reactive (y-axis) power. In one example, the controller can set the grid current vector as the unit for the circle.

In one example, meter 1140 generates data readings for the current of the local system, local 1142, as seen looking into connection point 1144. Connection point 1144 represents a node within the consumer premises. The controller can compute a current vector for the local system to compare against the grid vector. In one example, the controller maps the vector onto the unit circle. The magnitude can represent an amount of resources available to the local system to adjust the local operation to change what is seen by the grid.

In one example, meters 1130 and 1140 provide their data to gateway 1150 that implements iGOS 1152. In one example, gateway 1150 includes control 1154, which represents a controller to perform the calculations. Control 1154 can also represent the control signals to send to one or more power converters (not illustrated) of the consumer premises. Control 1154 can provide control over bidirectional energy transfer.

FIG. 11B represents an example of a 4-quadrant meter. Diagram 1160 represents an internal meter 1162 with input and output. The internal meters in any of the previous systems can be 4-quadrant meters. A 4-quadrant meter receives measurement data for a monitored point. The monitored point can be or include a solar system or other power generation. The monitored point can couple to a battery or other storage. The monitored point can include a power converter. The meter can provide output data to gateway 1150. Gateway 1150 represents a controller or “smarts box” that includes computer control 1154 to manage the energy generation and implement intelligence such as iGOS 1152.

Meter 1162 represents an example of either meter 1130 or meter 1140, or both meter 1130 and meter 1140. Meter 1162 receives as input 1170 the sensor or data measurement for the monitored node, such as described in the previous paragraph. Node 1172 represents the monitored node, whether grid facing or consumer facing, depending on where meter 1162 is implemented. Meter 1162 generates output 1180, which represents the measurements generated. In one example, meter 1162 generates current vector information. Meter 1162 can provide output data to gateway 1150. In one example, meter 1162 provides output to a controller in a circuit breaker enclosure box.

In one example of an enclosure, there are two meters implemented in accordance with meter 1162: one for local power generation and one for the PCC. In one example, the system includes an additional meter for a battery subsystem. In one example, each meter provides 4-quadrant monitoring of current for the monitored node, generating current vector information to provide to the iGOS to control the operation of the system to control how the power looks at each monitored node. By measuring behind the grid meter, the system can change the quadrant of operation behind the meter to cause the grid to see different operation at the consumer premises when looking from the grid side of PCC 1134.

In one example, a 4-quadrant meter can utilize a peripheral interface bus (e.g., an SPI bus) instead of serial ports, as is traditional with meter components. The SPI allows the meter to communicate information on a message basis instead of on a byte-by-byte basis. The message allows the meter to provide more or less information than a byte. In one example, meter 1162 accumulates information and provides more than a byte of information at a time. Meter 1162 can still service the messages per byte but allows the transfer of more information. The additional information can allow the system more data regarding what is happening, whereas byte-by-byte communication in a serial port may not provide sufficient information in a timely enough manner to make the computations needed to track specific current information. Thus, meter 1162 can provide increased information to the system as compared to traditional meters.

In one example, meter 1162 includes a timer that is set up with a DMA (direct memory access) service functionality to provide data directly to a memory. Such setup with a timer and DMA can allow the bypass of certain portions of the processing stack. When configured as mentioned above to allow message by message communication, meter 1162 can measure information directly into memory for analysis at the meter, by a processor that implements the measurement code. Such a setup enables the transfer of more metering data within a processing window to provide more time to make computations on the meter data. As such, the system can utilize finer-grain meter control within the system to make decisions regarding the operation of the converters and the generation of reactive power behind the grid meter.

In one example, the SPI interface is a synchronous interface. In one example, the DMA is implemented as a circular buffer. The code controlling meter 1162 can overwrite the setup timers to know when to read the data from the DMA buffer. The code can keep track externally of the start and stop of the meter data. Keeping track of the start and stop externally can be accomplished through an added abstraction layer on the meter processing algorithm. As such, the code can organize the meter data into bytes, where a byte of data, for example, can represent a reading. Such an approach gathers power data much faster than traditional approaches. The increased speed can enable accumulating and averaging power information right at the meter without having to use an external controller.

In one example, meter 1162 stores data for transfer to an iGOS controller, whether locally at the circuit box, or to an external gateway, or both. In one example, meter 1162 has logging build right into the meter. The logging can store thresholds for the storing of data. For example, if certain data exceeds certain thresholds, it can be flagged as an anomaly and dumped, for example, when data looks like a spike compared to other data around it. In one example, the iGOS system can poll meter 1162. In one example, meter 1162 pushes data to the iGOS. In one example, meter 1162 follows a schedule of data transfer to the iGOS system.

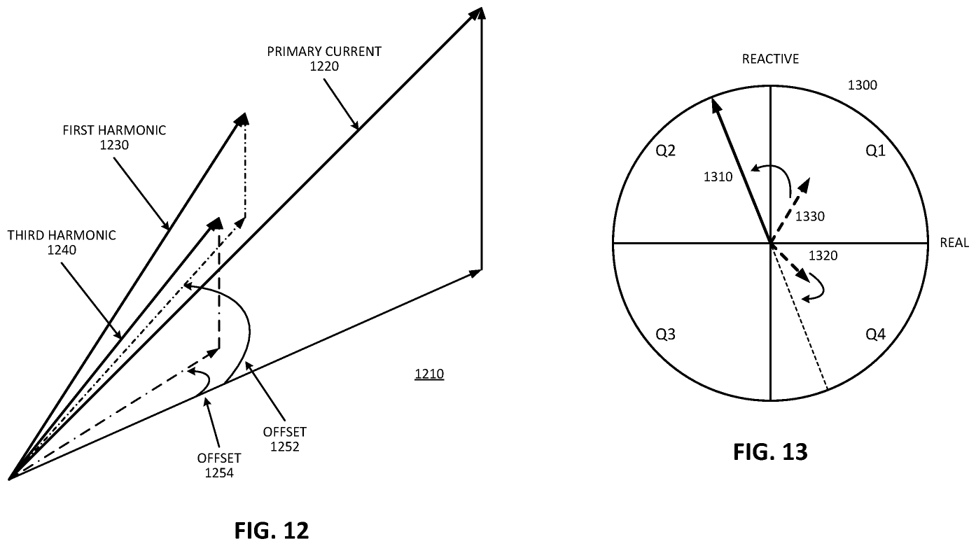

FIG. 12 is a graphical representation of an example of components of a current in a system in which harmonic components of current have angular offsets with respect to a primary current component.

Diagram 1210 provides a complex vector representation of current. A vector has a magnitude and a direction. Instead of simply measuring power as traditionally done, in one example, a meter (such as a meter in accordance with meter 1162 or meter 1140) can monitor power as an energy signature including a representation of a complex power vector. In one example, each signature identifies characteristics to define the signature. Each signature includes a complex vector representation that provides a vector for primary current and a vector for one or more harmonics.

Vector 1220 is the vector for primary current. In typical representation, the x-coordinate is the vector component that extends from left to right across the page. The y-component goes from bottom to top of the page. It will be understood that while not represented here for purposes of simplicity, a vector could have a negative y-component. The x-y coordinates define the end of the vector. Now assume that the x and y coordinates of primary current vector 1220 define a plane. The most correct way to envision the harmonics, in accordance with research and work done by the inventors, is to represent the harmonics as a three-dimensional vector. Thus, if the x-y coordinates of vector 1220 define a reference plane, one or more of the harmonics can have an angular offset relative to the plane of the primary current vector.

For example, consider the example of diagram 1210. The first harmonic is illustrated as having vector 1230, which includes an x component and a y component, where the magnitudes of the components can be any magnitude with respect to the primary current components. In addition to the x and y coordinates, first harmonic vector 1230 includes a z coordinate component, which defines angular offset 1252 of the current vector with respect to the reference plane of primary current vector 1220. It will be understood that the starting points of the primary current and the harmonics are the same. Thus, the third dimension of the harmonic vectors or the complex vectors is not necessarily an absolute z coordinate component, but an angular offset relative to the primary current.

As illustrated, third harmonic vector 1240 also has an x component and a y component, and angular offset 1254, which can be different (greater or less than) angular offset 1252 of first harmonic vector 1230. The angular shift of the angular offsets represents a magnetic effect on the current. The inventors have measured noticeable effects on power consumption up to the fortieth harmonic. Thus, the contribution of harmonic offsets should not be understated. The harmonics shift with respect to the angular offset due to the differing resonant effects of magnetic flux when trying to move a current. Primary current vector 1220 is the current the consumer expects to see. However, the harmonic components can add significant (measurable) power consumption. The offsets of the harmonics can shift the simple expected two-dimensional current vector into a three-dimensional current vector (complex current vector). The traditional power triangle does not fully address the power usage by the consumer, as additional power will be required to overcome the magnetic components represented by the shifted or offset harmonic components.

In one example, a controller or a gateway system makes current computations based on representations of currents in vector form in accordance with diagram 1210. In one example, a meter in accordance with meter 1162 or meter 1140 generates a vector representation of current for a monitored node and provides the data to a controller. The controller can not only identify signatures for different loads or different electrical circuits, but can identify a comparison of the grid current vector with the local current vector. The controller can send a request to a power converter to adjust operation of an output to shift the local current vector to a desired state based on where the grid vector is located on a 4 quadrant unit circle.

FIG. 13 is a graphical representation of an example of a grid current vector mapped against a local system current vector. Circle 1300 provides a representation of a current vector. In one example, circle 1300 illustrates diagrammatic information generated by a controller to map grid vector 1310 onto circle 1300.

In one example, the grid vector is obtained by measuring the grid current at the PCC. In one example, the grid vector is the reference vector, and thus circle 1300 can be normalized to the magnitude of vector 1310. Circle 1300 could be normalized to a different unit, such as the peak power of the consumer premises or the peak output capability of the consumer premises, where, for example, vector 1310 could represent the consumption of the consumer premises as seen at the PCC.

Circle 1300 includes two different local vectors for purposes of discussion, vector 1320 and vector 1330. In one example, a consumer premises will have only one local vector. In one example, a consumer premises includes multiple vectors based on different phases or different feeds supplied to the consumer premises.

Vector 1320 can represent where the current generation of the consumer system is at the time of measurement. In one example, the iGOS wants to shift vector 1320 to the dashed line to counteract vector 1310. Such a case could be true where vector 1310 represents consumption and vector 1320 represents generation. In another representation, the system could want to shift vector 1320 from quadrant 4 (Q4) to quadrant 2 (Q2) to align with vector 1310, if for example, the representation illustrates vectors that should be aligned for maximum efficiency. In one example, the consumer premises could have current vector 1330 in quadrant 1, which the system may want to shift to a different quadrant, such as inline with vector 1310 in quadrant 2.

It will be understood that different representations can be made of the grid vector and local vector or local vectors. The alignment or offset of those vectors can be different depending on different operation. For example, perhaps the system wants to move a local vector intentionally out of phase with the grid vector to ensure that the system provides reactive power support. Whatever the representation or the desired quadrant (which could be even more specific to a specific angle on circle 1300 within a desired quadrant), it will be understood that understanding the magnitude and angle of the vectors can allow the system to determine whether power converters should convert real power to reactive power, to adjust a mix of real and reactive power for the system, or otherwise how to shift operation.

In one example, as represented in circle 1300, a controller can make computations to determine the operations of the power converters by performing vector computations. Thus, the system can represent measured current waveforms in vector form, and perform vector computations to determine how to adjust the operation of the system to achieve the desired result. The system can compute vector calculations to determine a mix of real and reactive power needed, or to determine the mix of real and reactive power a power converter should output to shift operation of the system.

In one example, the size of circle 1300 is related to the phase difference between grid voltage (V) and current (I) of the consumer premises. The intersection of the circle with the positive vertical axis is VAR leading (at 13:00 on the circle) and the intersection with the negative vertical axis (at 6:00) is VAR lagging. Positive x-axis or leading VARs can indicate the VARs are provided from the utility, and negative x-axis or lagging VARs can indicate the VARs are supplied from the consumer premises to the grid.

Traditional DER solar panels push watts (W) back into the grid, which tends to push V and I apart. When there is a need for VARs and the traditional solar is flooding real power out onto the grid, the size of circle 1300 increases as V and I vectors diverge further. As described herein, the power converters can generate native reactive power (not reactive loading, but VAR injection) to stabilize the connection between the V and I vectors, which shrinks the circle and allows control of the quadrant of operation for the consumer premises.

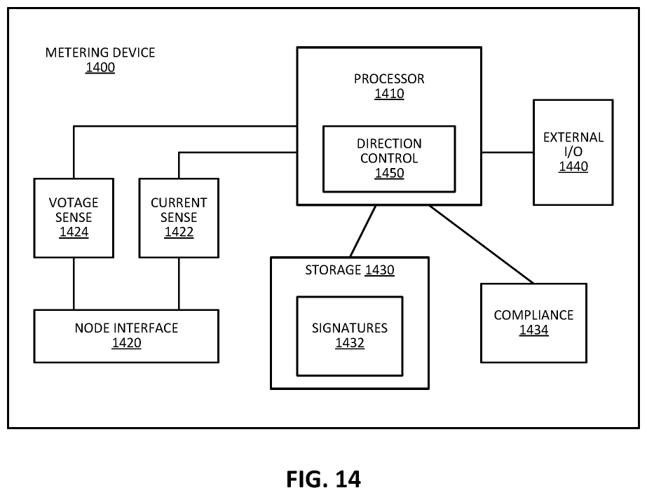

FIG. 14 is a block diagram of an example of a metering device that monitors power at a PCC with direction control. Metering device 1400 can be an internal meter or internal sensor in accordance with any example described. In one example, metering device 1400 is a sensor in an enclosure, such as in accordance with system 800.

Metering device 1400 includes hardware components to interconnect to a management system, such as a gateway device or other iGOS system. In one example, metering device 1400 includes node interface 1420, which represents hardware to enable metering device to measure or monitor the energy usage or production or both energy use and energy production of electrical circuits. In one example, metering device 1400 includes voltage sense hardware 1424 and current sense hardware 1422. Current sense hardware 1422 can measure current drawn at a monitored node or energy supplied into the node, and can include hardware capable to measure harmonic components of the measured power. Current sense 1422 can include magnitude, phase offset (e.g., power factor), frequency, or other electrical properties of a current waveform at the monitored node. In one example, metering device 1400 can generate energy signatures and compare such energy signature computations to stored energy signatures 1432. Metering device 1400 can also store new energy signatures computed as signatures 1432. Voltage sense hardware 1424 can measure a voltage including phase, frequency, magnitude, or other electrical property of the voltage waveform at the monitored node.

Processor 1410 represents control logic or a controller for metering device 1400. Processor 1410 can be configured or programmed to perform the energy monitoring. Processor 1410 can be configured to perform computations to compute energy signatures, generate complex current vectors, or compare current and voltage readings to energy signatures or other current vectors. In one example, processor 1410 determines how current can be adjusted to compensate for harmonics, a grid condition, or other condition to cause a monitored node to be at a desired current vector location on a unit circle.

Metering device 1400 includes external I/O 1440 to enable metering device 1400 to connect to other metering devices, or to connect to a management system of a consumer premises where metering device 1400 is implemented. In one example, external I/O 1440 enables metering device 1400 to send data to a gateway device.

In one example, metering device 1400 includes storage resources, such as memory or hard drives or solid state storage, represented as storage 1430. In one example, metering device 1400 stores signatures or vectors for local use by the metering device or as data to send to an external controller. The signatures or vectors are represented in metering device 1400 as signatures 1432, which can simply represent waveform data for a monitored node. The waveform data can include data that represents or that can be used to calculate a complex current vector representing a condition of a current waveform at the monitored node.

In one example, processor 1410 accesses one or more items of compliance information 1434. In one example, compliance information 1434 is stored in storage 1430. In one example, compliance information 1434 is received via external I/O 1440. In one example, processor 1410 computes a current waveform phase and shape desired for a given power demand scenario or power generation scenario based on compliance information 1434. Thus, compliance information 1434 can affect how metering device 1400 operates. In one example, external I/O 1440 enables metering device 1400 to couple to an associated converter or converters. Based on calculations made by processor 1410, in one example, metering device 1400 can signal a power converter how to operate to achieve the desired current. In one example, metering device 1400 simply indicates the desired current to the power converter, which can then separately compute how to generate the current. In one example, metering device 1400 computes specific parameters as input to a power converter device to cause it to adjust its operation for the desired current vector.

In one example, processor 1410 includes direction control 1450. Direction control 1450 represents the ability of metering device 1400 to send control signals to bidirectional interconnect hardware components to determine how energy is transferred and how the waveform is shaped. Waveform shaping enables interconnect hardware to receive or provide energy in a desired direction with a desired waveform shape. In one example, the waveform shaping is controlled by switching control of the interconnect circuitry. In one example, the waveform shaping is bidirectional waveform shaping. A device can be capable of bidirectional waveform shaping even if it only performs shaping in a single direction, depending on the application connected to it. In one example, processor 1410 can provide direction control 1450 based on EST computations.

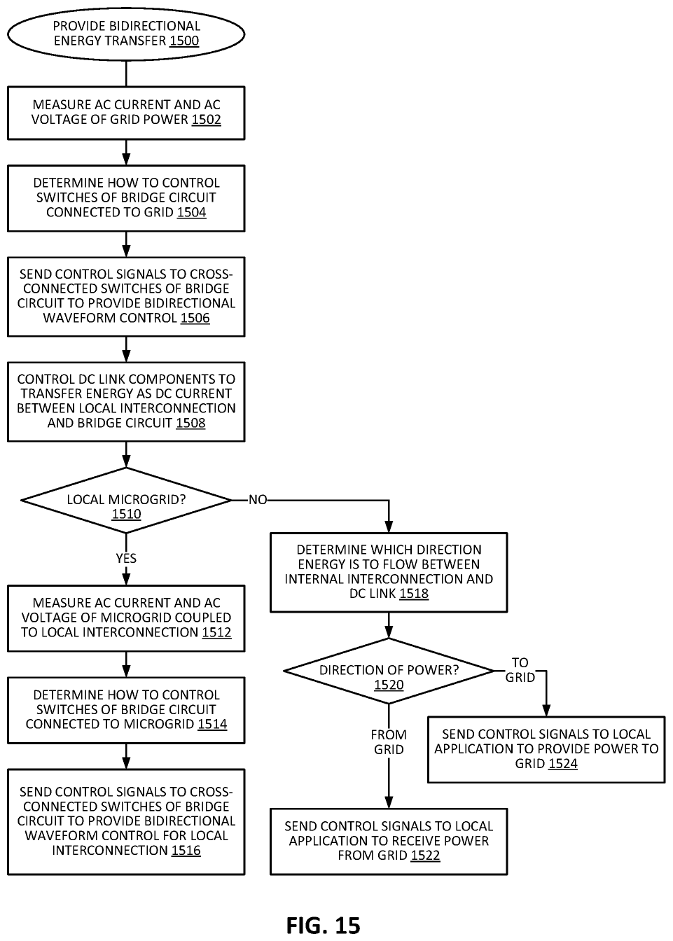

FIG. 15 is a flow diagram of an example of a process for providing bidirectional energy transfer. Process 1500 represents a process for providing bidirectional energy transfer in accordance with any interconnect device or interconnect system described.

In one example, sensors measure AC current and AC voltage of grid power, at 1502. In one example, a controller determines how to control switches of a bridge circuit, AC bridge, AC bridge circuit, or H-bridge that is connected to the grid, at 1504. The controller can send control signals to cross-connected switches of the bridge circuit to provide bidirectional waveform control, at 1506. While described as bidirectional waveform control, it will be understood that an AC current waveform that is controlled with waveform shaping will flow either toward the grid or away from the grid. Thus, bidirectional waveform control refers to the capability to provide the energy transfer in either direction, although the flow will only be in one direction at a time through a device.

In one example, the controller or processor controls components of a DC link to transfer energy as a DC current between a local interconnection to a local application and the bridge circuit, at 1508. The DC link can provide energy transfer with an energy reservoir between the connected application and the bridge and grid interconnect hardware.

In one example, the interconnection system can provide a microgrid environment. If the application connected to the local interconnection provides a local microgrid, at 1510 YES branch, the system can measure AC current and AC voltage of the microgrid coupled to the local interconnection, at 1512. The measurement can be with additional sensors that monitor power flow through the microgrid. The controller can determine how to control switches of a microgrid bridge circuit connected to the microgrid, at 1514. The controller sends control signals to cross-connected switches of the microgrid bridge circuit to provide bidirectional waveform control for the local interconnection, at 1516. The control for the local interconnection can include control for everything connected behind the local interconnection in the local microgrid.

In one example, if the application connected to the local interconnection does not provide a local microgrid, at 1510 NO branch, the system can determine based on the local application which direction energy is to flow between the internal interconnection or local interconnection and the DC link, at 1518. If the direction of power flow is from the grid, at 1520 FROM GRID branch, the controller can send control signals to the local application to cause it to receive power from the grid, at 1522. If the direction of power flow is to the grid, at 1520 TO GRID branch, the controller can send control signals to the local application to cause it to provide power to the grid, at 1524.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A power transfer device comprising:
a bridge circuit to couple to a power grid, the bridge circuit having cross-connected switches inline with a high voltage path of the power grid;
a direct current (DC) link to transfer energy as a DC current between a local interconnection and the bridge circuit; and
a controller to control the cross-connected switches of the bridge circuit to provide bidirectional waveform shaping of an alternating current (AC) current waveform to interconnect with the power grid, the bidirectional waveform shaping to shape the AC current waveform for energy transfer from the local interconnection to the bridge circuit for delivery of energy from the local interconnection to the power grid, and to shape the AC current waveform for energy transfer from the bridge circuit to the local interconnection for delivery of energy from the power grid to the local interconnection.

2. The power transfer device of claim 1, wherein the controller has control signals electrically isolated from the high voltage path to the cross-connected switches.

3. The power transfer device of claim 1, wherein the DC link comprises a first transformer facing the bridge circuit, a second transformer facing the local interconnection, and an internal node between the first transformer and the second transformer as an energy reservoir.

4. The power transfer device of claim 3, wherein the controller is to control the first transformer and the second transformer with high-speed switching to convert the AC current waveform into a pseudo-DC current.

5. The power transfer device of claim 1, wherein the local interconnection is to couple to transformers to couple to a battery.

6. The power transfer device of claim 1, wherein the local interconnection is to couple to transformers to couple to a load, the transformers to provide waveform shaping of energy delivered from the DC link to the load.

7. The power transfer device of claim 1, wherein the local interconnection is to couple to transformers to couple to a local energy source, the transformers to provide step-up for energy delivered from the local energy source to the DC link.

8. The power transfer device of claim 1, wherein the cross-connected switches comprise first cross-connected switches, and wherein the local interconnection is to couple to second cross-connected switches to provide a microgrid, wherein the controller is to control the second cross-connected switches with AC current waveform shaping independent of the AC current waveform shaping of the first cross-connected switches.

9. The power transfer device of claim 8, wherein the controller is to control the second cross-connected switches to provide bidirectional AC current waveform shaping between the microgrid and the DC link.

10. The power transfer device of claim 1, wherein the cross-connected switches comprise first cross-connected switches, and wherein the local interconnection is to couple to second cross-connected switches to provide a microgrid, and wherein the local interconnection is to couple to transformers in parallel with the microgrid.

11. A power transfer system comprising:
a grid interconnect to couple to a power grid;
a bridge circuit to couple to the power grid via the grid interconnect, the bridge circuit having cross-connected switches inline with a high voltage path of the power grid;
a local interconnect;
a direct current (DC) link to transfer energy between the local interconnect and the bridge circuit;
a sensor device to monitor alternating current (AC) voltage and AC current of the power grid on a grid side of the grid interconnect; and
a controller to control the cross-connected switches of the bridge circuit to provide bidirectional waveform shaping of an AC current waveform of the bridge circuit, the bidirectional waveform shaping to shape the AC current waveform for energy transfer from the local interconnect to the bridge circuit for delivery of energy from the local interconnect to the power grid, and to shape the AC current waveform for energy transfer from the bridge circuit to the local interconnect for delivery of energy from the power grid to the local interconnect.

12. The power transfer system of claim 11, wherein the controller has control signals electrically isolated from the high voltage path to the cross-connected switches.

13. The power transfer system of claim 11, wherein the DC link comprises a first transformer facing the bridge circuit, a second transformer facing the local interconnect, and an internal node between the first transformer and the second transformer as an energy reservoir.

14. The power transfer system of claim 11, further comprising:
transformers coupled to the local interconnect, the transformers to couple to a load to provide waveform shaping of energy delivered from the DC link to the load.

15. The power transfer system of claim 11, further comprising:
transformers coupled to the local interconnect, the transformers to couple to a local energy source to provide step-up of energy delivered from the local energy source to the DC link.

16. The power transfer system of claim 11, wherein the bridge circuit comprises a first bridge circuit with first cross-connected switches, and further comprising:
a second bridge circuit having second cross connected switches coupled to the local interconnect to provide a microgrid, wherein the controller is to control the second cross connected switches with AC current waveform shaping independent of the AC current waveform shaping of the first cross-connected switches.

17. The power transfer system of claim 16, wherein the controller is to control the second cross connected switches to provide bidirectional AC current waveform shaping between the microgrid and the DC link.

18. The power transfer system of claim 11, wherein the bridge circuit comprises a first bridge circuit with first cross connected switches, and further comprising:
a second bridge circuit having second cross connected switches coupled to the local interconnect to provide a microgrid; and
transformers coupled to the local interconnect in parallel with the microgrid.

19. A method for interconnecting to a power grid, comprising:
determining a direction of energy flow between a local interconnection and a grid interconnect to a power grid;
providing switching control for an alternating current (AC) bridge circuit the switching control to provide bidirectional waveform shaping of an AC current waveform to interconnect with the power grid, to shape the AC current waveform for energy transfer from the local interconnection to the AC bridge circuit for delivery of energy from the local interconnection to the power grid, and to shape the AC current waveform for energy transfer from the AC bridge circuit to the local interconnection for delivery of energy from the power grid to the local interconnection.

20. The method of claim 19, wherein providing the switching control for the AC bridge circuit comprises providing switching control for a first AC bridge circuit, and further comprising:
providing switching control for a second bridge circuit having second cross connected switches coupled to the local interconnect to provide a microgrid, to control the second cross connected switches with AC current waveform shaping independent of the AC current waveform shaping of the first cross connected switches.
